(19) United States
(12) Patent Application Publication
(10) Pub. No.: US 2025/0130776 A1
(43) Pub. Date: Apr. 24, 2025

(54) GENERATING PRODUCT PARAMETER SEEDS

(71) Applicant: DevRev, Inc., Palo Alto, CA (US)

(72) Inventors: Shlomi Vaknin, San Jose, CA (US); Amit Gosavi, Pune (IN); Dominik Damjakob, Austin, TX (US); Srividya Tata, Bangalore (IN)

(73) Assignee: DevRev, Inc., Palo Alto, CA (US)

(21) Appl. No.: 18/919,160

(22) Filed: Oct. 17, 2024

Related U.S. Application Data
(60) Provisional application No. 63/544,718, filed on Oct. 18, 2023.

(51) Int. Cl. G06F 8/20; G06F 21/62

(52) U.S. Cl. CPC G06F 8/20; G06F 21/62

(57) ABSTRACT

Techniques for generating product parameter seeds executable to obtain hierarchical product parameters for an offering operating in a unified platform are disclosed. The techniques include retrieving heterogenous data associated with the offering from the plurality of connected data sources being operated in connection with the unified platform. The heterogenous data comprises a plurality of sets of telemetry information related to the offering. The techniques further include generating the product parameter seeds, where the product parameter seed is a structured data object. Further, a signal is caused to be generated for transmission of the product parameter seeds executable to obtain the hierarchical product parameter.

### CROSS-REFERENCE TO RELATED APPLICATIONS

The present application claims the benefit of priority to U.S. Provisional Application 63/544,718, filed on Oct. 18, 2023, which is hereby incorporated by reference in its entirety.

### TECHNICAL FIELD

The subject matter of the present invention relates to the extraction of contextual data extracts from multiple data sources wherein such acquired data extracts can be transformed into components of a Part hierarchy. The subject matter described herein, in general, relates to generating a product parameter seed, and in particular to, generating the product parameter seed executable to obtain a hierarchical product parameter for an offering operating in a unified platform.

### BACKGROUND

An offering, such as a product and/or a service, offered by an organization typically encompasses several operational facets to satisfactorily meet diverse user demands. The several operational facets are often facilitated by various resources which operate in distinct environments. Since the several facets are unified in terms of the offering they are deployed to serve, the resources frequently exchange information for efficient and coherent functioning of the several facets. For instance, given a software product, the distinct environments may be a development environment and a user environment. The development environment typically includes tools, frameworks, and systems used by software engineers to design, code, test, and debug the product. On the other hand, the user environment encompasses the platforms, devices, and systems where end-users interact with and utilize the product.

### BRIEF DESCRIPTION OF DRAWINGS

A detailed description is provided with reference to the accompanying figures. In the figures, the left-most digit(s) of a reference number identifies the figure in which the reference number first appears. The same numbers are used throughout the drawings to reference features and components.

FIG. 1A illustrates an existing system to implement some embodiments of the invention.

FIG. 1B illustrates a block diagram of a connected environment, in accordance with an example implementation of the present subject matter.

FIG. 2 illustrates a block diagram of a comprehensive framework comprising hierarchical product parameters for an offering, in accordance with an example implementation of the present subject matter.

FIG. 3 illustrates schematics of a system for generating product parameter seed, in accordance with an example of the present subject matter.

FIG. 4A illustrates a data extractor of a Part discovery module to generate clues from distinct data sources, in accordance with an example of the present subject matter.

FIG. 4B illustrates a conceptual schematic for generation of product parameter seed, in accordance with an example implementation of the present subject matter.

FIG. 5A illustrates a block diagram of the clue-generating (extracting) module of the Part discovery module suitable for implementing an embodiment of the present subject matter.

FIG. 5B illustrates a conceptual schematic for generation of product parameter seed, in accordance with an example implementation of the present subject matter.

FIG. 6A illustrates a process of extraction and conversion of clues, in accordance with one of the embodiments of the present subject matter.

FIG. 6B illustrates a data flow for facilitating generation of the product parameter seed, in accordance with an example implementation of the present subject matter.

FIG. 7 illustrates a block diagram of a method for facilitating generation of a product parameter seed, in accordance with an example implementation of the present subject matter.

FIG. 8 illustrates a non-transitory computer-readable medium for facilitating generation of a product parameter seed, in accordance with an example of the present subject matter.

FIG. 9 illustrates a block diagram of an illustrative computing system suitable for implementing an embodiment of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

In modern connected computing environments, organizations frequently develop and deploy a wide range of products, services, and solutions across multiple discrete ecosystems. The products, services, and solutions may be collectively referred to as an offering and may encompass any deliverable that an organization may provide to its users or customers. For effective functioning, the offering may interface with a multitude of disparate locations, devices, and entities within the discrete ecosystems. The discrete ecosystems may be inhabited by, not limited thereto, both user-end entities and developer-end entities associated with the offering. The discrete ecosystems, while distinct, may not be entirely isolated as they operate towards a common organizational goal. Therefore, discrete ecosystems may at least be interconnected through shared resources, data, and dependencies, creating a complex web of interactions. Consequently, careful management and orchestration of the interactions between the resources becomes crucial for the successful operation of the offering within the interconnected computing environment.

The discrete ecosystems encompass a diverse set of resources, including hardware infrastructure, software platforms, data storage systems, network components, and the like. The resources may be intricately configured to collectively support the functionality and performance of the offering. As the operations progress in the discrete ecosystems, the diverse set of resources may generate continuous data streams pertaining to various activities or changes occurring within each ecosystem. While the data streams are typically unique to their originating ecosystem, they often reference entities and resources that span across multiple ecosystems.

The data streams may be used by the entities in the connected environment for generating and managing actionable items, for example, incidents, tickets, and issues. The actionable items are commonly associated with various sources and parameters related to the offering. The different sources and parameters may often correspond to specific segments of a comprehensive framework that encompasses the offering and multifaceted aspects of the offering.

In a typical enterprise, tickets or issues (work items) are associated with products and features. These features are manually created and often get out of sync with the latest deployments. There is a need for automated generation of new Parts (product/service) by collecting data from disparate sources used in the enterprise. The parts are hierarchical product parameters associated with an offering.

The comprehensive framework is composed of the hierarchical product parameters for the offering and different segments of the comprehensive framework relate to one or more hierarchical product parameters. The hierarchical product parameters represent a structured taxonomy of, for example, capabilities, features, microservices, sub-modules related to an offering. Further, a hierarchy comprising the hierarchical product parameters often includes multiple levels of granularity, ranging from high-level categories down to individual feature specifications.

In other words, the hierarchical product parameters for the offering are generally manually curated and maintained within the organization. However, the manual approach is inherently susceptible to inconsistencies and temporal misalignments with the actual state of a deployed offering. The discrepancy between the manually curated and maintained hierarchical product parameters and a current state of deployments, for example, real-time configuration updates for the resources, may lead to a cascade of operational inefficiencies. For instance, actionable items generated within an enterprise management system may reference outdated resources, potentially misdirecting the reference calls or causing delays in issue resolution. Moreover, if any modifications are made referencing outdated versions of the resources, the inconsistencies may propagate amongst other hierarchical product parameters and resources, affecting a wide range of functions.

The challenge is further aggravated by the rapid pace of modern software development and deployment practices, such as continuous integration and delivery (CI/CD) pipelines. The CI/CD pipelines enable frequent updates and feature releases, which can quickly render manually maintained product hierarchies obsolete. The discrepancies between manually maintained hierarchical product parameters and the actual state of deployments can have far-reaching consequences beyond operational inefficiencies. Such discrepancies may impact strategic decision-making as organizations may base their plans on outdated or inaccurate representations of the offering's capabilities. Additionally, the inconsistencies may affect user experience and satisfaction, as support teams may provide incorrect information or troubleshooting steps based on outdated hierarchical product parameters.

Embodiments of the present subject matter provide an improved method, system, and computer readable memory to process and integrate data and events from disparate ecosystems about products or services. These embodiments address a significant problem of conventional development and customer relations management (CRM) systems, which is that developers, producers, or providers (“dev”) are isolated from their users/customers (“rev”). Removing barriers between the “Dev” side and the “Rev” side permits embodiments of the invention to easily connect code on the Dev side to production issues and user/customer interactions on the Rev side.

One or more implementations of the present specification provide a method of generating clue(s) wherein the generation of clues includes extracting meaningful data extracts from distinct data sources and converting them into a data structure known as Part clue for a new Part formation. Embodiments of the invention may act upon any number or type of event hierarchies. In accordance with the embodiments, clue generation is dependent on various data sources (wherein sources are generic but customer specific; not all resources are mandatory), which are typically used by the customers to gather Part clues (meaningful data extracts) which will be essential for deducing Dev/Rev Parts. This method of generating clues for Parts discovery is easily extensible to multiple resources. A clue generator converts the Data collected (extracted and converted) to clues, wherein clues of a similar kind are in a uniform format. The clues are intermediary memory structures that can be further stored in a data storage entity for further processing, assessment, learning statistical analysis, etc.

In accordance with one or more implementations of the present specification, a Part discovery module performs monitoring of Parts functioning, discovering new Parts from existing event hierarchy components, and updating the existing Parts' table. In an embodiment, the Part discovery module generates clues (meaningful data extracts) by collecting data from disparate sources used in the enterprise and converting them into a clue similar to a Part component in event hierarchy. These clues finally materialize into Parts in the event hierarchy (Developer-Revenue) system. The function of the clue in the Developer-Revenue event hierarchy is to automatically develop or create Parts (about a product or service). The Part discovery module involves the auto-discovery of Parts without the customer having to create them manually. The clues are hereinafter interchangeably referred to as product parameter seeds and the parts are interchangeably referred to as hierarchical product parameters.

The present subject matter envisages techniques for generating a product parameter seed. The techniques exhibit capability to interface with diverse data sources distributed across a connected environment, in relation to the offering. The data sources may include code repositories, deployment logs, monitoring systems, customer support databases, user analytics platforms, and the like. The techniques allow for extraction of relevant information from heterogeneous data streams originating from various ecosystems. For example, information about new features from recent code commits, usage statistics from analytics platforms, and common issues from support tickets may be extracted from heterogeneous data. The extracted information may then be synthesized into product parameter seeds which serve as a foundation for developing robust hierarchical product parameters or modifying existing hierarchical product parameters. The hierarchical product parameters generated based on the product parameter seeds are in coherence with current system states and may be seamlessly integrated into an existing hierarchy pertaining to an offering. Owing to the thorough and real-time development of the product parameter seeds, the techniques allow for a dynamic and responsive system that adapts to real-time changes in the offering's ecosystem.

The product parameter seeds may be executable to obtain a hierarchical product parameter for an offering. Obtaining the hierarchical product parameter may include either generating a new hierarchical product parameter or modifying an existing hierarchical product parameter. The offering may be a product, a service, or a combination of both. Further, in one example, the offering may have components operating in distinct ecosystems in a connected environment. The distinct ecosystems may be connected through a unified platform where an organization may integrate and manage various aspects of an offering's operations, resources, and processes. The unified platform may be implemented, for example, as a Software-as-a-Service (SaaS) platform. The unified platform acts as a central hub unifying the distinct ecosystems within which various components of an offering operate, thereby enabling a holistic approach to generating and maintaining accurate product parameter seeds and hierarchical product parameters. For instance, the unified platform may integrate data from a development ecosystem (e.g., code repositories, build systems), an operations ecosystem (e.g., deployment logs, performance monitoring), and a customer-facing ecosystem (e.g., support tickets, usage analytics).

In accordance with one or more implementations of the present specification, a Part discovery module monitors Parts, discovers new Parts from existing event hierarchy components, and updates the existing Parts' table. In accordance with one or more embodiments, a new Part construction is automated through the processing of clues, wherein the processing of clues comprises the generation (extraction) of clues, the Partitioning of clues into Partitions, and the merging of each Partition clue set to form a Part component in the event hierarchy. These clues materialize into Parts in the event hierarchy (Developer-Revenue) system. The function of the clue in the event hierarchy is to automatically develop or create Parts (about a product or service). The Part Discovery module is able to configure and customize a profile, that defines which sources to use; the type of extractors, partitioners, and mergers to be implemented; and any configuration required that might influence the result of discovering Parts.

In one aspect, the Part discovery module generates clues (meaningful data extracts) by collecting data from disparate sources used in the enterprise and converting them into a similar format clue of a Part. The Part discovery module comprises multiple data extractors for distinct data sources (like Git, Datadog, Kubernetes, Custom, and organizational table (Partiql, Codex, Pinning)) wherein the data from the data source is extracted using a suitable data extractor. The clues generation is executed by a clue generator, wherein the clue generator analyzes the data extracts (from distinct sources) and converts each data extract into a standard format to represent the data structure of the Part in the event hierarchy. Each data field with defined attributes in the clue refers to or is directed towards a common object (here, it is a Part related to a product or a service).

In other words, the clue-generating module of the Part discovery module comprises a data extractor to extract data (event data, structured data, unstructured data) from multiple sources; a data collector to store extracted and converted data; a clue generator which collects the stored data from the data collector and other available data sources (mongo database record comprising event data like Git events) to generate clue (meaningful extract or isomorphic form of a Part) that automates the construction of a new Part (product/service) in the event hierarchy of an organization. In one of the embodiments, the clue-generating module, further comprises a gateway to transfer data from the data extractor to the data collector. The data collector stores event data extracted from sources like monitoring applications that tracks changed state in operations and record such changed state as the event data. The data extractor further extracts dependencies in a package or a repository; and extracts files containing a build specification of the package or the repository, wherein the clue-generating module construct clues from the build specification.

Particularly, the part discovery module may, in response to receipt of a data retrieval signal, trigger data acquisition to acquire data from a plurality of connected data sources. Each connected data source, from the plurality of connected data sources, may be connected with the unified platform. In an example, the data retrieval signal may be received from an entity connected with the unified platform. Further, as a result of data acquisition, heterogeneous data associated with the offering may be retrieved from the plurality of connected data sources. The heterogenous data may include a plurality of sets of telemetry information, related to the offering, available with the plurality of connected data sources. The telemetry information may include, for example, usage statistics indicative of a number of times a hierarchical product parameter, (for example, a feature) has been accessed, event logs (logs of incidents, tickets, and issues generated), performance data (response time, resource utilization, etc.), user navigation patterns, Application Programming Interface (API) calls and patterns, configuration snapshots, A/B test results for new hierarchical product parameters, crash reports.

Further, each of the plurality of sets of telemetry information comprises a diversified set of attributes associated with the offering. For example, the diversified set of attributes may assist in identifying information such as hierarchical product parameter version number and release, average user rating and sentiment analysis, dependencies on other hierarchical product parameters, integration capabilities with third-party services, and the like.

Upon retrieving the plurality of sets of telemetry information, a plurality of insight packages may be derived for each set of telemetry information. The plurality of insight packages may include a set of semantic information and a set of contextual markers. The derivation of insight packages may involve sophisticated data processing techniques to extract meaningful patterns and relationships from the raw telemetry data. For example, for obtaining the semantic information, a large language processing model may be executed to extract relevant semantic content from the heterogenous data comprising the plurality of sets of telemetry information. The large language processing model may identify key concepts, entities, and their relationships within the telemetry data, providing a deeper understanding of the offering's functionality and user interactions. The set of contextual markers, on the other hand, may capture important metadata and situational information surrounding each telemetry data point. The metadata and situational information may include temporal data (such as timestamps), spatial information (like geolocation), technical details (e.g., originating device information), and qualitative assessments (such as sentiment analysis related to the telemetry information). By combining semantic insights with rich contextual data, the insight packages may provide a comprehensive view of the offering's performance, usage patterns, and potential areas for improvement or expansion.

The set of contextual markers in the plurality of insight packages may include relational context information. The relational context information provides data indicative of relationships between one or more of the plurality of sets of telemetry information within the unified platform. The relationships may include dependencies, where one feature or microservice relies on another for proper functioning. For instance, a particular microservice might depend on specific API calls or database access patterns. The analysis may also reveal correlations, such as patterns of simultaneous usage or performance fluctuations across different components. Accordingly, the relational context information may map how different features, capabilities, and microservices are structured within the unified platform.

Each of the plurality of insight packages may be a discrete data set associated with each set of telemetry information. Each insight package may encapsulate a specific aspect or dimension of the offering's performance, usage, or functionality, allowing for granular analysis and targeted improvements. For instance, one insight package might focus on user interaction patterns with a particular feature, while another could contain performance metrics for a specific microservice. Such a modular approach provides flexibility in determining how the data can be combined or cross-referenced to derive higher-level insights.

Further, a tag may be obtained for each of the plurality of insight packages. Each tag may be a reference that may be used for identifying one insight package. The tag may be generated through various techniques, including a user-initiated prompt, automated classification algorithms, natural language processing of the contents of the insight package, or predefined taxonomies based on the offering's structure and features. Multiple tags may be assigned to a single insight package, creating cross-referencing capabilities. Therefore, tagging may facilitate the creation of dynamic relationships between different insight packages, enabling discovery of complex patterns or correlations that might not be immediately or directly apparent. The tags serve as unique identifiers or labels that allow for efficient retrieval, categorization, and analysis of the insight packages within the system.

The plurality of insight packages and the obtained tags are then augmented to each set of telemetry information from amongst the plurality of sets of telemetry information. By augmenting the derived insight packages and their corresponding tags to raw telemetry information, a comprehensive and contextually enriched dataset may be created that may ease a discovery process for the hierarchical product parameter.

Further, a subset may be selected from the augmented plurality of sets of telemetry information. The selection of the subset may be based on a set of rules that define which parameters are relevant for generating the hierarchical product parameter. The set of rules may be either preset or may be defined on-the-fly by a user of the unified platform. The parameters may include, but are not limited to, usage frequency, performance impact, user feedback, business priorities, and strategic alignment. Additionally, the set of rules may include user-initiated filtering criterion, allowing for customized selection based on specific analytical needs or development focuses. The subset of augmented telemetry information may be selected such that information optimally positioned to contribute to the generation of meaningful and actionable hierarchical product parameters is obtained.

Further, the subset may be used to generate the clues. The clues may also be referred to as product parameter seeds that automate the construction of a new part. The product parameter seed is a structured data object comprising information associated with each augmented set of telemetry information in the subset. The product parameter seed may be a JavaScript Object Notation (JSON), Extensible Markup Language (XML), or Ain′t Markup Language (YAML) file, that encapsulates comprehensive information about the offering, including its capabilities, features, and microservices. The product parameter seed is generated by synthesizing the augmented telemetry data, potentially leveraging large language processing models to ensure accurate representation. In accordance with one of the embodiments, dev clues are transformed into Dev Parts, and rev clues are transformed into Rev Parts. For the Dev Part, distinct source data is differentiated, and code work is developed to extract clues (such as commits or PRs linked to an enhancement). A group of clues (based on name similarity) containing a definite source is considered a Dev Part. For Rev Parts, Rev Clues are grouped based on their API endpoint paths and then transform each clue into a Part. Non-grouped API paths are grouped as a miscellaneous Rev Part.

Once generated, a signal may be generated to transmit the product parameter seed to be used for obtaining a hierarchical product parameter. Obtaining the hierarchical product parameter may refer to generating a new hierarchical product parameter in one example, and modifying an existing hierarchical product parameter in another example. The dynamic creation and transmission of the product parameter seed ensures that the hierarchical product parameter that may be generated or updated remains current and accurately reflects the actual state of the offering within the unified platform. The approach facilitates agile development practices, enables rapid response to changing conditions, and supports data-driven decision-making across the unified platform.

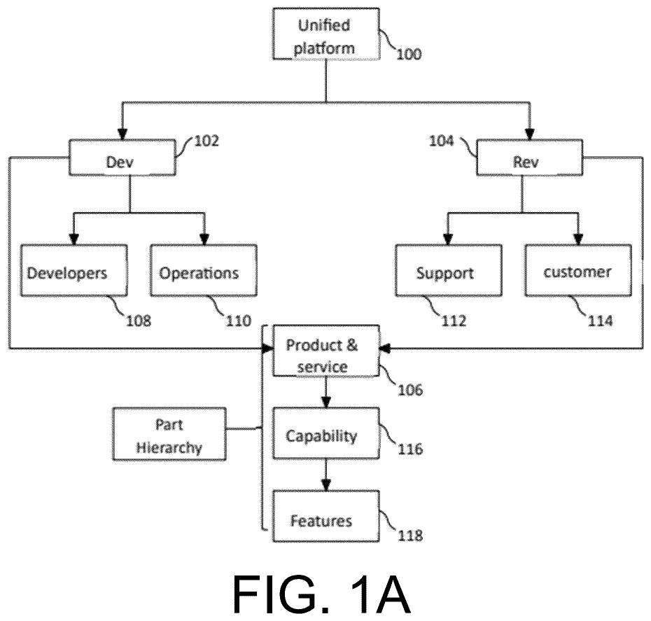

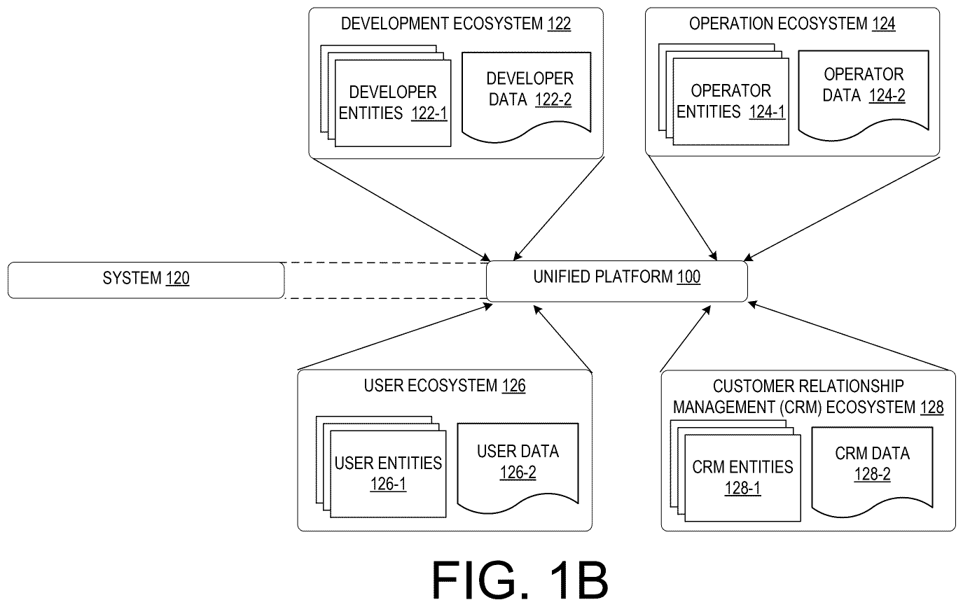

The present subject matter is further described with reference to FIGS. 1-9. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1A illustrates a unified platform 100 to implement an automated template for automatically clustering events into event hierarchies and independent classification and communication between these hierarchies. FIG. 1B provides a block diagram of a connected environment, in accordance with an example implementation of the present subject matter. For sake of brevity, FIG. 1A and FIG. 1B have been explained in conjunction with each other.

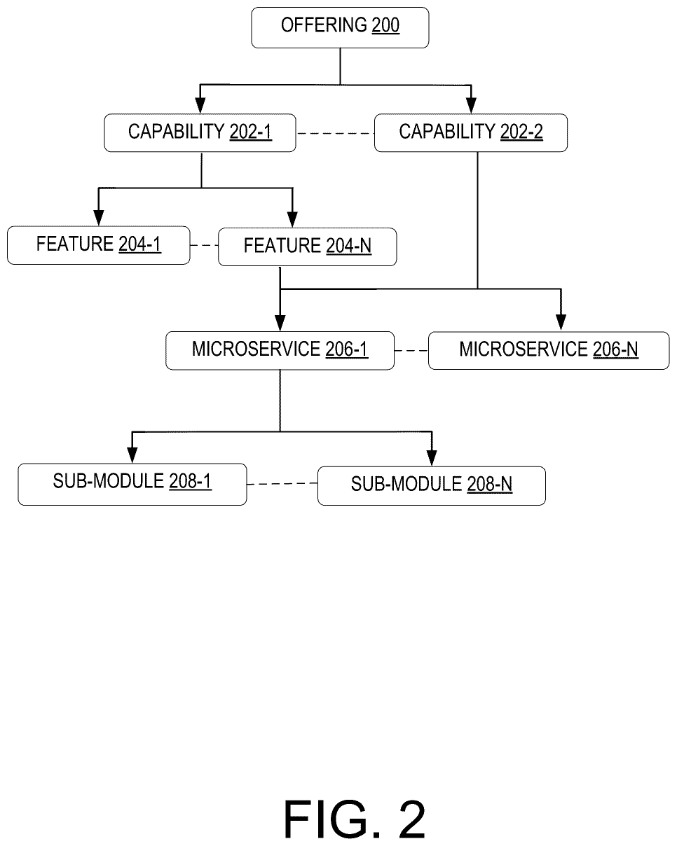

Event hierarchies are classified as Development-related hierarchies 102 and Revenue-related hierarchies 104. Development-related hierarchies 102 are further classified into two sub-event hierarchies, a developer hierarchy 108 and an operation hierarchy 110. The developer hierarchy 108 pertains to systems used by and interfaced with software developer activities that are used to “build” the software product, and the operations hierarchy 110 pertains to development-related personnel that operate the systems/software for a computing product. Revenue-related hierarchies 104 are further classified into two sub-event hierarchies: support hierarchy 112 and user/customer hierarchy 114. The support hierarchy 112 pertains to systems used by user and customer-facing support personnel, and the user/customer hierarchy 114 pertains to ordinary customers and users using the actual products. The events generated by the different hierarchies comprise a Part hierarchy centered around the ‘Product’ or ‘Service,’ 106 the primary entity to which all Parts are related and branched. A Product or Service 106 is defined as a set of capabilities 116, the lowest level in the Part hierarchy where revenue can be assigned, a market category is created or attributed, and it is the core unit with which the consumer interacts. A ‘Capability’ 116 is defined with an independent set of features prominent enough to define a minimum product offering that can be measurable, observable, upgradable, and potentially monetizable. Capabilities 116 can have configurable items classified as feature 118, wherein feature 118 is specific to capability 116 and can be enabled, metered, or tracked for usage. Further, feature 118 provides entities and associated actions and/or toggles that can be executed (e.g., create, update, enable, disable) on the provided entities. Capabilities 116 may have an API namespace if delivered as a software product or service and can have associated service level agreements (SLA). Features can further be classified into sets of operations, wherein operations are a collection of actionable interfaces with which the customer interacts, as will be explained later in relation to FIG. 2.

The connected environment represents a comprehensive network of interconnected systems, devices, and services that collectively support the operation and management of an offering. The offering may be the product and service 106. An offering may be onboarded with the unified platform 100 and the unified platform 100 may be responsible for supporting and maintaining distinct functions in relation to the offering. The unified platform 100 may incorporate technologies such as cloud computing, containerization, microservices architecture, and the like.

In an example, the unified platform 100 may be hosted by a system 120. The system 120 is a Part discovery module responsible for monitoring Parts, discovering new Parts from existing event hierarchy components, and updating the existing Parts' table. The system 120 may include any type of equipment that may be used to implement, operate, or interface with the unified platform 100. The system 120 may be, for example, workstations, personal computers, mobile devices, servers, hosts, nodes, or remote computing terminals.

The unified platform 100 may connect development-related hierarchies 102 and revenue-related hierarchies 104 and may comprise various discrete ecosystems, each of which may focus on different specific aspects of the offering, such as development, deployment, operation, and user interaction. The operation of the unified platform 100 involves analysis of large amounts of data streams captured from the distinct ecosystems to identify events occurring at the distinct ecosystems for processing by the unified platform 100. The unified platform 100 may implement autonomous processing of the events to generate items of interest to one or more entities operating in distinct ecosystems.

The discrete ecosystems, while distinct in their primary functions, may be intricately linked through the unified platform 100. In an example, the discrete ecosystems may include a development ecosystem 122, an operation ecosystem 124, a user ecosystem 126, and a customer relationship management (CRM) ecosystem 128. The development ecosystem 122 and an operation ecosystem 124 may form a part of developer-related hierarchies 102, and the user ecosystem 126 and the CRM ecosystem 128 may form part of the revenue-related hierarchies 104. For instance, the development ecosystem 122 may be a part of the developer hierarchy 108 and the operation ecosystem may be a part of the operation hierarchy 110. Similarly, the user ecosystem 126 may be a part of the customer hierarchy 114 and the CRM ecosystem 128 may be a part of the support hierarchy 112.

The discrete ecosystems, while operating independently to some degree, are interconnected through the unified platform 100, allowing for a holistic approach to managing the offering's lifecycle and ensuring consistent performance and user experience across all aspects of the offering. The system 120 hosting the unified platform 100 may be connected with different computing devices hosted across the connected environment through a network (not shown).

The system 120 may be communicatively coupled to computing devices (not shown) associated with each of the discrete ecosystems either through a direct communication link, or through multiple communication links of the network. The network may be a wireless or a wired network, or a combination thereof. The network may be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the network includes various network entities, such as gateways and routers; however, such details have been omitted to maintain the brevity of the description.

Any number or type of data streams generated by the distinct ecosystems may be acted upon by embodiments of the present subject matter. The development ecosystem 122 may inhabit a plurality of developer entities 122-1 and may generate data streams comprising developer data 122-2. The development ecosystem 122 may be related to aspects of building the offering and various components related to the offering. For example, the development ecosystem 122 may encompass various tools, platforms, and processes used in the creation and maintenance of the offering. The tools and platforms may include integrated development environments (IDEs), version control systems, continuous integration/continuous deployment (CI/CD) pipelines, code review tools, and testing frameworks. The developer entities 122-1 may represent individual software engineers, development teams, or automated systems involved in the coding, testing, and deployment processes. Further, the developer data 122-2 generated in the data streams originating from the developer entities may include code commits, pull requests, build logs, test results, code coverage reports, and performance profiling data. The developer data 122-2 may provide information regarding the evolution of the offering, identifying potential issues early in the development cycle, and maintaining code quality.

Further, the operation ecosystem 124 may inhabit a plurality of operation entities 124-1 and may generate data streams comprising operation data 124-2. The operation ecosystem 124 may be related to aspects of deployment, monitoring, updating, and maintenance of the offering in the connected environment. For example, the operation ecosystem 124 may include tools, platforms, and processes used in infrastructure management (Cloud platforms, on-premises servers, containerization technologies (e.g., Docker, Kubernetes), and virtual machines), monitoring and alerting systems (Prometheus, Grafana, Nagios, Datadog, and the like), log management solutions (Centralized logging systems such as ELK (Elasticsearch, Logstash, Kibana) stack or Splunk), performance optimization tools, and the like. The operation entities 124-1 may represent individual system administrators, DevOps engineers, and site reliability engineers. Further, the operation data 124-2 generated in the data streams originating from the operation entities may include server logs, performance metrics, resource utilization statistics, container orchestration metrics, CDN (Content Delivery Network) edge server performance, and incident reports. The operation data 124-2 may assist in determining the reliability, scalability, and efficiency of the offering in real-world usage scenarios.

The user ecosystem 126 may inhabit a plurality of user entities 126-1 and may generate data streams comprising user data 126-2. The user ecosystem 126 may be related to aspects of interaction of end-users with the offering. For example, the user ecosystem 126 may include various client devices, operating systems, network conditions, and the like. The user entities 126-1 may represent the end-users. Further, the user data 126-2 generated in the data streams originating from the user entities 126-1 may include usage patterns, feature adoption rates, user feedback, and error reports. The user data 126-2 may provide information useful for understanding user behaviour, identifying areas for improvement, and guiding future development priorities.

The CRM ecosystem 128 may inhabit a plurality of CRM entities 128-1 and may generate data streams comprising CRM data 128-2. The CRM ecosystem 128 may be related to aspects of managing relationships and interactions of customers with the offering. For example, the CRM ecosystem 128 may include customer support platforms, sales management tools, marketing automation platforms, chatbot systems, user journey mapping tools, and the like. The CRM entities 128-1 may include sales representatives, technical support engineers, feedback analysts, service chatbots, Artificial Intelligence (AI) assistants, and the like. Further, the CRM data 128-2 generated in the data streams originating from the CRM entities 128-1 may include customer inquiries, support tickets, sales data, and sentiment analysis metrics. The CRM data 128-2 may provide information useful for understanding customer needs, improving support processes, and identifying upselling or cross-selling opportunities.

The unified platform 100 hosted by the system 120 is thus configured to interface with diverse data sources, such as the various entities in the discrete ecosystems (the development ecosystem 122, the operation ecosystem 124, the user ecosystem 126, and the CRM ecosystem 128), across the connected environment. The unified platform 100 thus allows for extracting relevant information from heterogeneous data streams originating from the various entities in the discrete ecosystems of the connected environment. The system 120 may be configured to integrate the heterogeneous data from the various discrete ecosystems and understand complex relationships and contexts within the heterogenous data, potentially uncovering insights that might not be apparent through the traditional data analysis techniques. The context and insights may alert towards the requirement of certain modifications in one or more of the different aspects of the offering. Further, the heterogenous data and the derived insights and context may be used to generate product parameter seeds. The product parameter seeds may be executable to generate or update one or more aspects related to the offering. The present subject matter outlines an application of the inventive method for the Software-as-a-Service (SaaS) industry, but it is not limited to this industry.

FIG. 2 illustrates a block diagram of a comprehensive framework comprising hierarchical product parameters for an offering, in accordance with an example implementation of the present subject matter. The comprehensive framework standardizes a hierarchy of product parameters ensuring consistency and coordination across all entities and data from the discrete ecosystems in the unified platform 100 (as discussed with reference to FIGS. 1A and 1B). Each element in the hierarchy may be referred to as a hierarchical product parameter. The structure and specific product parameters of the hierarchy may vary depending on a type of offering 200. The offering may be a product and service 106 discussed in relation to FIG. 1A. Though the description here focuses on software-based offerings, the disclosures of the present specification may be adapted for other products or services.

The offering 200 forms the foundational entity for which the hierarchy is constructed. The offering 200 is defined as a unit of profit and loss, identity, onboarding, and contracting purposes. The offering 200 may encompass multiple hierarchical product parameters, arranged in a top-down structure of increasing granularity forming the part hierarchy shown in FIG. 1A. At the highest level of granularity, the offering 200 may include capabilities such as capabilities 202-1, 202-2, . . . , and 202-N, where N is a natural number. The capabilities 202-1, 202-2, . . . , and 202-N may be singly referred to as a capability 202 and collectively referred to as capabilities 202. The capability 202 is the capability 106 discussed in relation to FIG. 1A. The capability 202 represents a core functional unit with which an end user may directly interact. For example, in a customer relationship management (CRM) software offering, the capabilities 202 may include “Contact Management,” “Sales Pipeline,” or “Email Marketing.”

At the next level of granularity, each capability 202 may be composed of one or more features 204, such as features 204-1, . . . , and 204-N. The features 204-1, . . . 204-N may hereinafter be singly referred to as a feature 204 and collectively as features 204. The feature 202 is the feature 118 discussed in relation to FIG. 1A. The feature 204 is another hierarchical product parameter having a specific functionality within a capability 202. The feature 204 is typically not directly interacted with by the end-user but may be essential to the operation of the capability 202. For instance, within the “Contact Management” capability as discussed above, features may include “Contact Deduplication,” “Custom Fields,” or “Activity Tracking.”

In software-based offerings, the capabilities 202 and/or the features 204 are often supported by backend constructs, which form additional levels in the hierarchy of product parameters. The additional levels may include microservices 206-1, . . . 206-N and sub-modules 208-1, . . . 208-N. The microservices 206-1, . . . 206-N may hereinafter be singly referred to as a microservice 206 and collectively as microservices 206. Similarly, the sub-modules 208-1, . . . 208-N may hereinafter be singly referred to as a sub-module 208 and collectively as sub-modules 208. The microservices 206 and the sub-modules 208 may represent the technical implementation of the higher-level functionalities. For instance, the “Contact Management” capability, as discussed above, may be supported by microservices 206 such as “Contact Data Storage”, “Contact Search”, and “Contact Synchronization”. The microservices 206 may further rely on sub-modules 208 such as database connectors, caching mechanisms, or third-party Application Programming Interface (API) integrations.

The microservice 206 may be a deployable unit of software that may support one or more features 204 or contribute to a capability 202. As illustrated in FIG. 2, the feature 204-N may be based on the microservice 206-1. In another example implementation as depicted in FIG. 2, the capability 202-N may be formed based on a combination of microservice 206-1 and the microservice 206-N. Further, the microservice 206-1 may be implemented using the sub-module 208-1 and the sub-module 208-N. The sub-module 208 may be meant as part of an entity in the connected environment, but not the entity as a whole.

For software-based offerings, the offering 200 may have an Application Programming Interface (API) namespace and associated service level agreements (SLA). The capability 202 may be conceptualized as a set of entities (noun) and activities (verbs) associated with the each provided entity. Each capability 202 may have configurable elements that manifest as one or more features 204 or contribute to the capability 202. Extending the noun/verb analogy used above, the feature 204 may define specific attributes (adjectives) of functions performed at an entity within one of the distinct ecosystems explained in relation to FIG. 1.

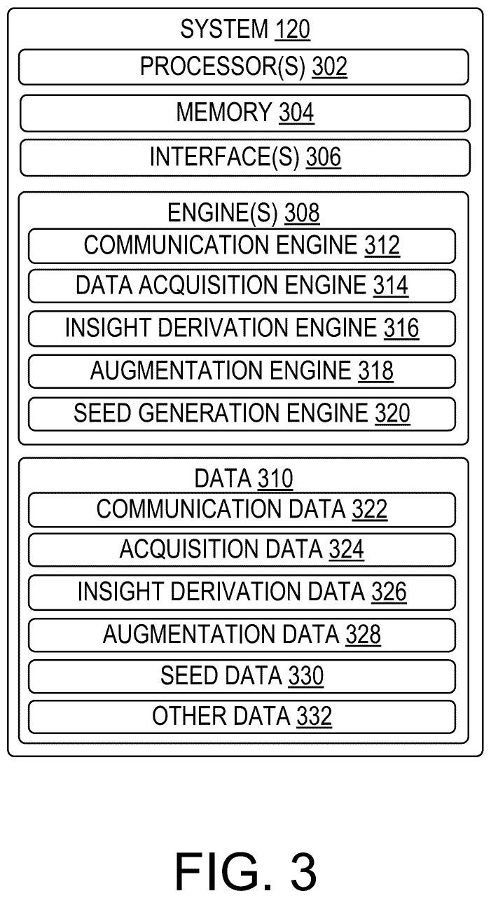

FIG. 3 illustrates schematics of the system 120 for generating product parameter seed, in accordance with an example of the present subject matter. As already described, the system 120 may host the unified platform 100 and the unified platform 100 may communicate with the discrete ecosystems in the connected environment. The system 120 may implement the part discovery module on the unified platform. FIG. 3 illustrates additional aspects of the part discovery module, with reference numbers and elements that may be drawn from FIGS. 1 and 2 as explained above. Similar or identical components may retain the same reference numbers across figures for consistency.

The system 120 may include a processor(s) 302 to run at least one operating system and other applications and services. The system 120 may further include a memory 304 coupled to the processor(s) 302, interface(s) 306, engine(s) 308, and data 310.

The processor(s) 302, amongst other capabilities, may be configured to fetch and execute computer-readable instructions stored in the memory. The processor(s) 302 may be implemented as one or more microprocessors, microcomputers, microcontrollers, digital signal processors, central processing units, state machines, logic circuitries, and/or any devices that manipulate signals based on operational instructions. For instance, the processor(s) 302 may include specialized AI accelerators or Graphic Programming Units (GPUs) optimized for machine learning tasks. The functions of the various elements shown in the figure, including any functional blocks labelled as “processor(s)” or “processing unit”, may be provided through the use of dedicated hardware as well as hardware capable of executing machine readable instructions.

When provided by the processor(s) 302, the functions may be provided by a single dedicated processor, by a single shared processor, or by a plurality of individual processors, some of which may be shared. Moreover, explicit use of the term “processor(s)” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. For example, the system 120 may utilize FPGAs for real-time data processing and ASICs for specific, high-performance tasks like encryption or data compression. Other hardware, conventional and/or custom, may also be included. The processor(s) 302 may include routines, programs, objects, components, data structures, and the like, which perform particular tasks or implement particular abstract data types. The processor(s) 302 may further include modules that supplement applications on the system 120, for example, modules of an operating system. Further, the processor(s) 302 may be implemented in hardware, instructions executed by a processing unit, or by a combination thereof.

The memory 304 may be coupled to the processor(s) 302 and may, among other capabilities, provide data and instructions for performing different functions. The memory 304 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 304 may store the information received and in possession of the system 120 as data 310.

The interface(s) 306 may include a variety of machine-readable instructions-based interfaces and hardware interfaces that allow the system 120 to interact with different components, such as the processor(s) 302, the memory 304, the engines 308, and the data 310. Further, the interface(s) 306 may enable the system 120 to communicate with computing devices, for example, the computing devices in the discrete ecosystems communicate with the system 120, web servers, and external repositories. The interface(s) 306 may facilitate multiple communications within a wide variety of networks and protocol types, including wireless networks, wireless Local Area Network (WLAN), RAN, satellite-based network, and the like. For instance, the interface(s) 306 may support protocols such as Hyper Text Transfer Protocol Secure (HTTPs, Message Queuing Telemetry Transport (MQTT) for, and Remote Procedure Calls (RPCs).

The engine(s) 308 may be implemented as a combination of hardware and firmware or software. In examples described herein, such combinations of hardware and firmware may be implemented in several different ways. For example, the firmware for the engine(s) 308 may be processor executable instructions stored on a non-transitory computer-readable storage medium and the hardware for the engine(s) 308 may include a processing resource (for example, implemented as either a single processor or a combination of multiple processors), to execute such instructions.

In the present examples, the machine-readable storage medium may store instructions that, when executed by the processor(s) 302, implement the functionalities of the engine(s) 308. In such examples, the system 120 may include the machine-readable storage medium storing the instructions and the processor(s) 302 to execute the instructions. In other examples of the present subject matter, the machine-readable storage medium may be located at a different location but accessible to the system 120 and the processor(s) 302. The engine(s) 308 may include a communication engine 312, a data acquisition engine 314, an insight derivation engine 316, an augmentation engine 318, and a seed generation engine 320 coupled with each other. The data acquisition engine 314 may be a data extractor of the part discovery module and the seed generation engine may be a clue generator of the part discovery module. The insight derivation engine 316 and the augmentation engine 314 may process the data to enable the seed generation engine 320 to generate clues. The clues may be interchangeably referred to as product parameter seeds.

The system 120 may further include data 310, that serves, amongst other things, as a repository for storing data that may be fetched, processed, received, or generated by the engine(s) 308. The data 310 may include communication data 322, acquisition data 324, insight derivation data 326, augmentation data 328, seed data 330, and other data 332. In an example, the data 310 may be stored in the memory 304.

In an example implementation, the system 120 may receive a data retrieval signal. The data retrieval signal may be received from an entity operating in association with the unified platform 100 in the connected environment. The entity may be associated with the offering 200 and may be one of the developer entities 122-1, the operator entities 124-1, the user entities 126-1, and the CRM entities 128-1. For example, a developer entity 122-1 may send a data retrieval signal to gather information about recent code commits and associated performance metrics.

The receipt of the data retrieval signal may be enabled by the communication engine 312 of the system 120. The communication engine 312 may be configured to distinguish a data retrieval signal from other signals. As a response to the receiving of the data retrieval signal, the communication engine 312 may trigger the data acquisition engine 314 to initiate data acquisition. The trigger may be sent through an internal messaging system, a function call, or a dedicated signal pathway within the system 120. The communication engine 312 may store an indication of the data retrieval signal and associated details as communication data. The associated details may include, for example, one or more of the timestamp of the signal, the source entity, the specific data requested, any parameters or filters specified in the request, the priority level of the retrieval task, and the like.

Upon receiving the trigger to initiate data acquisition, the data acquisition engine 314 may initiate data acquisition from a plurality of connected data sources. The connected data sources may be one or more entities generating data streams in the discrete ecosystems, as discussed in relation to FIG. 1B. The unified platform 100 hosted by the system 120 may connect various data sources within the connected environment. The connected data sources can be defined as any unit or component within the connected environment that may generate data streams pertaining to the offering 200. Such sources may include, but are not limited to, sensors, devices, systems, or other data-producing entities relevant to the operation or performance of the offering 200, for example in the discrete ecosystems as explained in relation to FIG. 1B. In the example, the connected data sources may be one of the developer entities 122-1, the operator entities 124-1, the user entities 126-1, and the CRM entities 128-1. For instance, a connected data source might be a CI/CD pipeline in the development ecosystem 106, generating data about build statuses, test results, and deployment frequencies.

In an example, the data streams generated by the connected data sources may either be published automatically to the unified platform 100 and consequently to the system 120. Alternatively, the data acquisition engine 314 may access a System of Records (SoR) hosted at each of the distinct ecosystems in the connected environment. The SoR may be understood as a data repository hosted locally at each of the distinct ecosystems in the connected environment and may store the data streams generated at each of the distinct ecosystems.

The data acquisition engine 314 may implement or reference one or more data capturing tools to capture data from the connected data sources using any suitable mechanism or technique. For example, the data capturing tools may include, but are not limited thereto, connectors, rover(s), and/or Application Programming Interfaces (APIs).

In an example, the connectors may enable bi-directional communications between the system 120 and the connected data sources. For example, the connectors may be used with respect to CRUD (“create, read, update, delete”) operations being performed in the connected data sources. A connector might be implemented using a technology like Apache Nifi®, which may provide a scalable and secure way to ingest and transform data from various sources.

Further, the rover(s) may be used to implement data collection in a single direction from the entities operating in the distinct ecosystems. For example, the rover(s) may collect logs, alerts, jobs, and usage data from the entities operating in the distinct ecosystems. The rover(s) may be implemented for each possible connected data sources operating in the connected environment in relation to the offering 200. In some embodiments, the rover(s) may operate with a pull approach, which may provide a one-way path to obtain information into the system 120 and operate as a data-feed. For instance, a rover might be implemented as a lightweight agent deployed on servers in the operation ecosystem 108, periodically collecting system metrics and sending them back to the unified platform 100. The pull approach may work well with entities from which data just need to be consumed without necessarily needing synchronization in the other direction, such as a log file or message store. In contrast, the connector(s), which is bi-directional, synchronizes data between the connected data sources, and permits data to be published in both directions. The connector(s) therefore requires a greater level of access, which may necessitate the establishment of privileges, creation of an ongoing session, and/or permissions.

To illustrate the different scenarios in which the rover(s) may be used instead of the connector(s), or vice versa, consider a software development organization that may use a software source control system to manage its coding projects. If there is a desire to merely publish data streams to the system 120, then a one-way pull component such as the rover may be used to capture information from that source code control system. For example, a rover might periodically fetch commit logs and code diff information from a Git® repository. On the other hand, the system 120 may desire the ability to be able to open, update or close actionable items that are created in the source control system, based upon an analysis that may occur at the system 120. In such case, the connector may implement two-way communication that may allow the actionable items to be created, updated, or closed. For instance, a connector might integrate with a project management tool like Jira®, allowing the system 120 to both read issue statuses and create new issues based on the analysis of existing actionable items.

Furthermore, the APIs may implement programmatic access to the connected data sources and pull data from the connected data sources. These APIs might be RESTful web services, GraphQL® endpoints, or gRPC services, depending on the specific requirements of the connected data source and the system 120.

As part of the associated data with respect to the data retrieval signal, reference to one or more marked data sources may be present. The one or more marked data sources may include reference to one or more data sources from amongst the plurality of connected data sources. The presence of the one or more marked data sources may indicate that the data acquisition is to be performed only from the marked data sources and not upon the entire set of the connected data sources. Therefore, the marked data source may be understood as a target for directing the data acquisition. For example, if the data retrieval signal is related to investigating a specific performance issue, the marked data sources may include only the relevant application servers and database instances, rather than the entire infrastructure.

The information regarding the reference to the one or more marked data sources may also be stored as the communication data 322. The communication data 322 relevant to the data retrieval signal may also be transmitted by the communication engine 312 while signaling the data acquisition engine 314 to trigger data acquisition.

The data acquisition engine 314 may determine the presence of the reference to the marked data sources in the data retrieval signal and based on the determination the data acquisition may be performed to retrieve data only from the marked data sources. The data acquisition engine 314 may perform the data acquisition from the marked data sources in a similar manner as discussed above with respect to the plurality connected data sources. Directing the data acquisition from only relevant data sources, such as the marked data sources, may significantly save the processing costs and provide more relevant data for further processing. For instance, if investigating a user-reported bug, the marked data sources may include only the specific microservices involved in the affected user flow, rather than the entire application stack.

Prior to triggering the initiation of data acquisition from either the entire set of connected data sources or from the marked data sources, the data acquisition engine 314 is to obtain, in one example, access permission. The access permission may be obtained from either the connected data sources or from the marked data sources based on the data sources being queried. The access permission may include at least a read permission. However, the access permission may also include a write permission, a modify permission, or any other permission as may be necessary to perform further processing on the data to be acquired from the connected data sources. In an example, access permissions may be managed through a centralized identity and access management (IAM) system, such as OAuth 2.0™ or SAML™. In another example, the access permissions may be managed internally at each connected data source or at each discrete ecosystem inhabiting the connected data source.

The data acquisition engine 314 may store the captured information as acquisition data 324. The acquisition data 324 may include heterogenous data associated with the offering 200. Heterogenous data may refer to diverse types of information collected from various sources across the connected environment, encompassing structured data (such as database records), semi-structured data, and unstructured data (including log files, text documents, and multimedia content). The heterogeneous data may vary in format, schema, and semantics, reflecting the diverse nature of the discrete ecosystems and their respective data-generating entities.

The heterogeneous data may include a plurality of sets of telemetry information related to the offering 200. The plurality of sets of telemetry information may include or may be based on the data streams generated in the discrete ecosystems in the connected environment. The plurality of sets of telemetry information may include data collected from the discrete ecosystems that may provide insights into the performance, usage, and behavior of the offering 200 and related hierarchical product parameters. In an example, the telemetry information may include the structured data, the semi-structured data, the unstructured data such as usage statistics, event logs, performance data, user navigation patterns, API calls and patterns, configuration snapshots, A/B test results, crash reports, network traffic data, access control modifications, and the like. The telemetry information provides a comprehensive view of the offering's operation, enabling data-driven decision-making and continuous improvement. The telemetry information may be stored as the acquisition data 324. In an example, a set of telemetry information, acquired from the development ecosystem, may include information from a code repository and CI/CD pipeline. The development ecosystem may include a version control system (for example, a Git) integrated with the CI/CD pipeline to manage and deploy a microservice. The set of telemetry information may include code commits, pull requests, build processes, and the like.

In an example, the acquisition data 324 may be stored in the memory 304. In another example, the acquisition data 324 may be stored at a location remote to the system 120 and may be interfaced with by the system 120. Further, in the example, while storing the acquisition data 324, the system 120 may de-duplicate or update the data already present in the memory 304. The data acquisition engine 314 may also record indication of any relationships between different objects in the acquisition data 324.

The system 120 may further analyze the telemetry information to derive a plurality of insight packages for each set of telemetry information from the plurality of sets of telemetry information stored as the acquisition data 324. The insight derivation engine 316 may enable the derivation of the plurality of insight packages. The insight derivation engine 316 may process the plurality of sets of telemetry information to determine a set of semantic information and a set of contextual markers. The insight derivation engine 316 may access and execute a large language processing model for processing the plurality of sets of telemetry information to extract the set of semantic information and the set of contextual markers. The set of semantic information may refer to the actual content and meaning extracted from the set of telemetry data and may represent substantive insights, patterns, or knowledge derived from analyzing the telemetry data. Further, the set of contextual markers may be metadata elements that may provide background information regarding the circumstances under which the set of telemetry data is generated.

The large language processing model, executed by the insight derivation engine 316, may be a pre-trained model such as GPT-3, BERT, a custom-trained model specific to the domain of the offering, or a fine-tuned large language model (LLM) that has been adapted for a specific task or dataset related to the offering. Further, the insight derivation engine 316 may employ techniques such as natural language processing (NLP), sentiment analysis, named entity recognition, and part-of-speech tagging to extract meaningful insights from the plurality of sets of telemetry information. For instance, part-of-speech tagging may be utilized to specifically identify nouns when analyzing API paths.

For example, when processing telemetry information from the CRM ecosystem 128, the insight derivation engine 316 may identify common themes in customer complaints, extract, sentiment scores, and recognize specific hierarchical product parameters mentioned in support tickets. The set of semantic information may include frequently occurring issues or pain points, user sentiment towards specific hierarchical product parameters, emerging trends in user behavior or preferences, and the like. The set of contextual markers, on the other hand, may include timestamp of the support interaction, user demographic information, geolocation, originating device information, and the like.

The insight derivation engine 316 may also derive relational context information as part of the sets of contextual markers. The relational context information may include data indicative of relationships between one or more of the plurality of sets of telemetry information within the unified platform 100. To extract the relational context information, the insight derivation engine 316 may use graph analysis algorithms, association rule mining, time series analysis, causal inference models, and the like. The insight derivation engine 316 may further analyze the relational context information to identify at least one of dependencies, correlations, and hierarchical relationships between the plurality of sets of telemetry information. For example, by analyzing the relational context information, the insight derivation engine 316 may discover that the performance of a particular microservice is critically dependent on the response time of a specific database access request sub-module. Further, the correlations may help identifying that increased usage of one feature is strongly correlated with high user retention rates. Such information may provide useful insight on whether an existing hierarchical product parameter needs any modification, enhancement, or a new hierarchical product parameter needs to be developed and/or deployed.

The derived set of semantic information and the set of contextual markers may be bundled as the insight packages for each set of telemetry information. Further, each of the plurality of insight packages may be structured as a discrete data set associated with the telemetry information. The insight derivation engine 316 may further obtain a tag for each of the plurality of insight packages. Each tag may be a reference for identifying one insight package, acting as a unique identifier or label for the insight package. The tag may be obtained using automated classification using a user input received by the communication engine 312, multi-label classification algorithms, hierarchical tagging systems, fuzzy matching algorithms to associate insights with predefined taxonomies, and the like. The tags may enable rapid identification and categorization of insight packages, allowing for efficient organization, searchability, and actionability for obtaining a hierarchical product parameter within the unified platform. By associating each insight package with one or more tags, the system can create a flexible and powerful indexing system, enhancing the ability to navigate and utilize the derived insights effectively.

The plurality of insight packages may be stored as insight derivation data 326. In an example, the insight derivation data 326 may be stored in relation with the acquisition data 324. Subsequent to the insight derivation, the augmentation engine 318 may augment the plurality of insight packages and the obtained tags to the each set of telemetry information from amongst the plurality of sets of telemetry information. The augmentation engine 318 may create data structures that link the plurality of sets of telemetry information with its corresponding insight package and tags. For example, the augmentation engine 318 may use a key-value store where the key is a unique identifier for the telemetry information and the value is a composite object containing the set of telemetry information, the derived insight packages, and associated tags. In another example, the augmentation engine 318 may employ a graph database structure where nodes may represent sets of telemetry information, and edges may represent relationships to the insight packages and tags. Each set of augmented plurality of insight packages may be stored as augmentation data 328. The augmentation engine 318 may also involve updating existing data structures to include new insight packages and tags, ensuring that the augmentation data 328 remains current and reflective of the current state of the unified platform.

Further, the seed generation engine 320 may select a subset from the augmented plurality of sets of telemetry information. The seed generation engine 320 may base the selection on a set of rules defining parameters relevant for generating the hierarchical product parameter. The set of rules may be implemented as a series of conditional statements or decision trees. The set of rules may either include a user-initiated filtering criterion or a pre-defined filtering criterion. The user-initiated filtering criterion may be input through a graphical user interface and translated into query parameters. Further, the seed generation engine 320 may utilize the relational context information in the selection of the subset from the augmented plurality of sets of telemetry information. In an example, the seed generation engine 320 may leverage graph traversal algorithms to identify interconnected data points that collectively provide a comprehensive view of a particular aspect of the offering.

The seed generation engine 320, upon selecting the subset may generate the product parameter seed based on the subset. As discussed above, the seed generation engine 320 may be a clue generator of the part discover module and may generate clues. The clues are interchangeably referred to as product parameter seeds. A product parameter seed may be a structured data object comprising information associated with each augmented set of telemetry information in the subset of the augmented plurality of sets of telemetry information. The seed generation engine 320 may collect all relevant data points from the selected subset, including raw telemetry information, derived insight packages, and associated tags. Further, the seed generation engine 320 may normalize the collected data to ensure consistency in format and scale across different data types and sources. Further, in an example, the seed generation engine 320 may extract key features from the normalized data using techniques such as principal component analysis (PCA) or autoencoders. The extracted features may be combined with the information from the insight packages to synthesize relevant information for the product parameter seed. Subsequently, the seed generation engine 320 may format the synthesized information into a structured data object that may be the product parameter seed. The product parameter seed may be executable to obtain a hierarchical product parameter for an offering operating in a unified platform. The structured data object may be in one of a JavaScript Object Notation (JSON) file, an Extensible Markup Language (XML), Ain′t Markup Language (YAML), Protocol Buffers, and combinations thereof. In an example, the seed generation engine 320 may attach relevant metadata including priority level to the product parameter seed. The product parameter seed may be stored as seed data 330. For example, the product parameter seed may include a JSON file comprising notification from the operations ecosystem 108:

```
...json
{
  “partition_value”: “notifications”,
  “partition_by”: “Datadog partitioner − inferred linkable”,
  “dev_part_type”: Runnable,
  “extractor”: “custom-dev”,
  “source”: “custom-routes”,
  “id”: @custom Routing-routingRules::notifications”,
  “name”: “notifications”
}
...
```

The communication engine 312 may further cause generation of a signal for transmission of the product parameter seed executable to obtain the hierarchical product parameter. The communication engine 312 may access the seed data 330 to generate the signal.

Further, the other data 332 may include various types of information that do not directly fit into the categories of communication data 322, acquisition data 324, insight derivation data 326, augmentation data 328, or seed data 330, but are still relevant to the overall functioning of the system 120. For example, the other data 332 may encompass configuration data, user data including information regarding the users of the system 120, audit trails, caching data, machine learning modes, scheduling information, error logs, and the like.

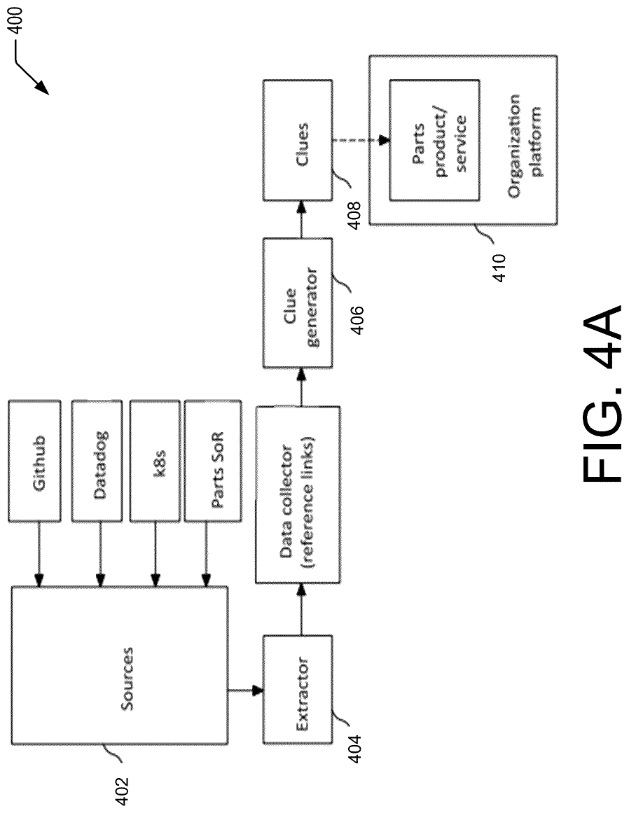

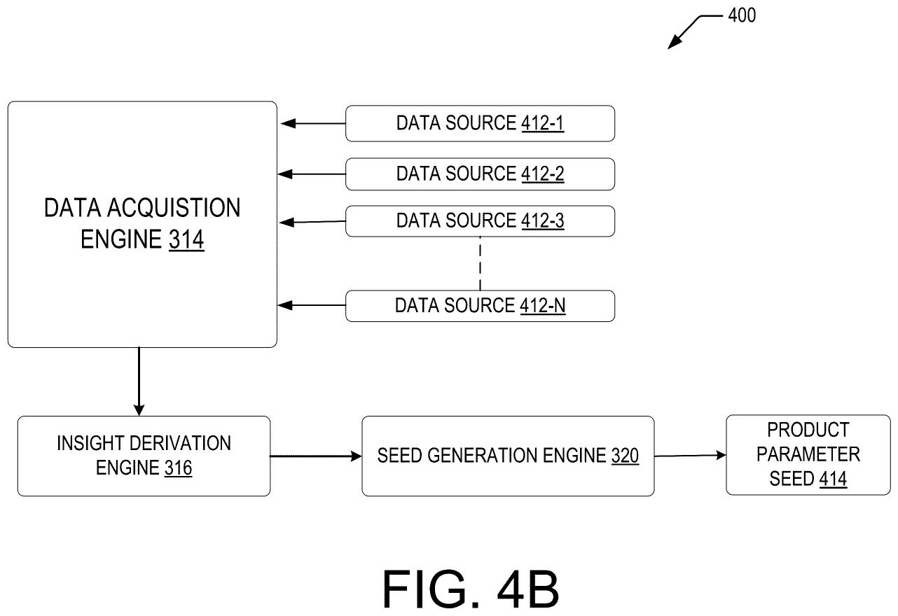

FIG. 4A illustrates a data extractor of a Part discovery module to generate clues from distinct data sources, in accordance with an example of the present subject matter. FIG. 4B illustrates a conceptual schematic for generation of product parameter seed, in accordance with an example implementation of the present subject matter. FIGS. 4A and 4B has herein forth been explained in conjunction. In the following description of FIGS. 4A and 4B, reference will be made to the elements and features described in FIGS. 1A to 3 and the detailed description provided above.

In accordance with one of the exemplary embodiments of the specification, the Part discovery module comprises multiple data extractors 404 for distinct data sources 402 (like Git, Datadog, Kubernetes, Custom, existing Parts data in the organizational table (Partiql, Codex)) wherein the data from the data source is extracted using suitable data extractor. The data collector stores all the extracted data extracts and transfers such data extracts to the clue generator 406 to convert the data extracts into clues 408. The data from all sources are represented in a standard format called a Part clue. The clues 408 generated can be transformed into an independent Part. A clue 408 is an isomorphic form of a Part component 410, which may or may not comprise all data fields or attributes defined in the Part (object with defined data fields). Data storage of the Part discovery module facilitates independently storing the Parts created using the clues extracted from each data source.

In one of the embodiments, method of generating clues for parts discovery comprising extracting data from data sources; storing extracted data to a data collector; transferring stored data from the data collector and an event data to a clue generator; and generating clue to automate construction of a Part in an event hierarchy.

In an example, the data acquisition engine 314 corresponding to the extractor 404 may acquire data from a plurality of connected data sources. The plurality of connected data sources may include data source 412-1, data source 412-2, data source 412-3, . . . , and data source 412-N. The data source 412-1, data source 412-2, data source 412-3, . . . , and data source 412-N may hereinafter be collectively referred to as data sources 412 and individually as data source 412.

The data acquisition engine 314 may acquire heterogenous data of varying data types from a variety of data sources from among the data sources 412. In an example, but not limited thereto, the data source 412-1 may be a version control system, for example, GitHub®. Further, the data source 412-2 may be a monitoring and analytics system, for example, Datadog®. Furthermore, the data source 412-3 may be a container orchestration system, for example, Kubernetes®. Additionally, the data source 412-N may be a SoR hosted locally in one or more of the discrete ecosystems. The above-mentioned exemplary data sources have been shown in FIG. 4A.

For each data source type, the data acquisition engine 314 (corresponding to the extractor 404 of FIG. 4A) may employ an acquisition tool, for example, the connectors, the rovers, the APIs, as explained above. The acquisition tools may store all the acquisition data. The acquisition data 324 may be accessed by the seed generation engine 320 (corresponding to the clue generator 406 of FIG. 4A) that may process the acquisition data and convert the acquisition data into a product parameter seed 414 (corresponding to the clues 408 of FIG. 4A). In an example, the acquisition data 324 may be accessed by the insight derivation engine 316 prior to the seed generation engine 320. The product parameter seed 404 may be an isomorphic form of a hierarchical product parameter, which may comprise all data fields or attributes defined in the hierarchical product parameter.

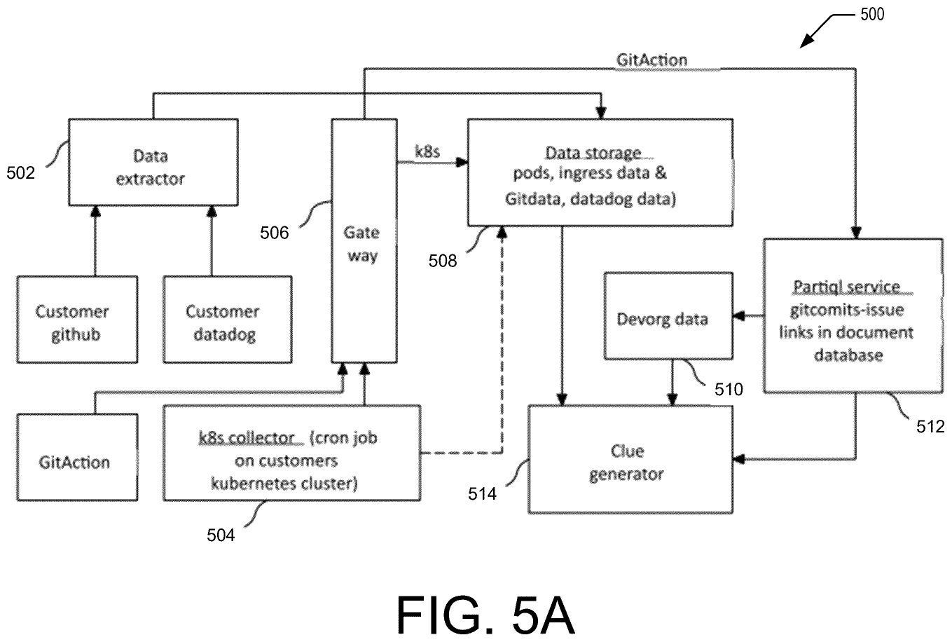

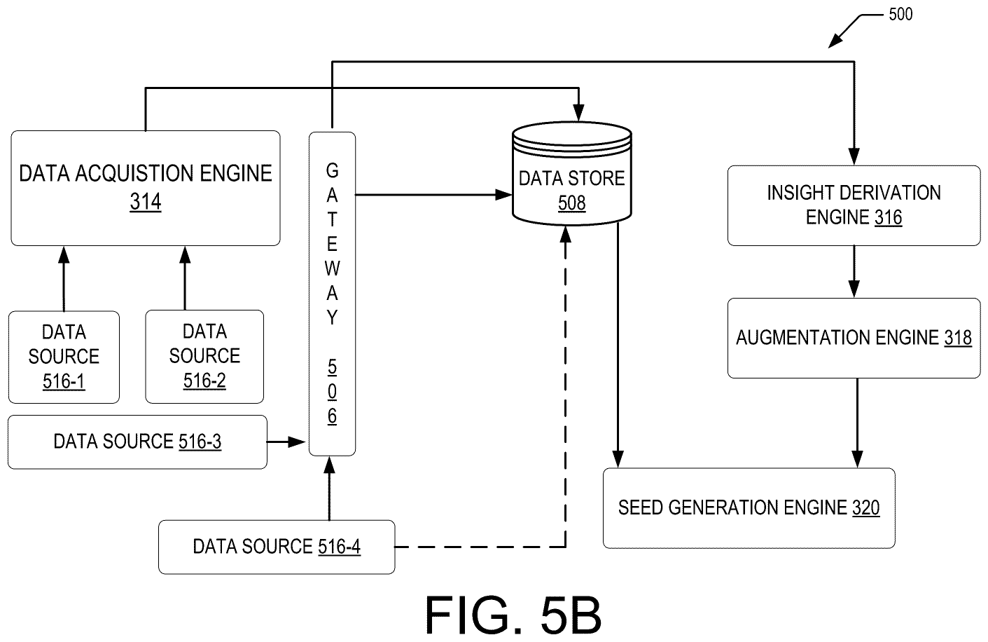

FIG. 5A illustrates a block diagram of the clue-generating (extracting) module of the Part discovery module suitable for implementing an embodiment of the present subject matter. FIG. 5B illustrates a conceptual schematic for generation of product parameter seed, in accordance with an example implementation of the present subject matter. FIGS. 5A and 5B has herein forth been explained in conjunction. In the following description of FIGS. 5A and 5B, reference will be made to the elements and features described in FIGS. 1 to 4B and the detailed description provided above. For the sake of brevity, the full descriptions of these elements and features will not be reproduced here, but are incorporated by reference and should be understood as applicable. FIGS. 5A and 5B have been explained to provide an exemplary implementation of the system 120 described in FIG. 3.

The clue-generating module of the Part discovery module, in accordance with one of the exemplary embodiments of the present specification, comprises a data extractor 502, which collects data and extracts data from distinct sources. For each data source type, an independent extractor is suitable for extracting data extracts (event data, structure data). For example, cloud-scale applications data, data events collected from monitoring of servers, databases, tools, and services through a SaaS-based data analytics platform (like datadog), and event data like tracking source changes (git data) are collected and converted into an open standard format or a data interchange format (like JSON). Such converted data files are transferred into a data storage 508. Other data from sources like Kubernetes (software deployment, scaling, and management), wherein a collector 504 (kubernetes collector) is installed on the customer's cluster (where their other kubernetes services are running) to gather data on the kubernetes services deployed in the customer environment and the extracted event data is converted into open standard format file (JSON) and uploads it to data storage through an API call which goes through the gateway 506. Real-time event data from Git Actions (e.g., pull request opened) and pull request's associated issues is obtained through GitHub webhook, through gateway 506 into the Partiql service. It is processed in the Partiql service 512 and stored in Mongo as Git Events. The event data from the existing Parts is extracted from the Partiql service. The data collected from sources and stored (such as Git data, datadog service data, pods, ingress data, existing Parts' table, Git Events) is transferred to a clue generator 514, which generates a clue that is meaningful data extract (isomorphic variation of a Part) to automate the generation of a Part component (Part, Capability, Feature) of the event hierarchy.

The data extractor 502 is achieved by collecting data from distinct sources like (customer Git and customer Datadog data records). The data from a source like Git is extracted based on an established customer connection to a Git provider (Github, Gitlab, etc.). During scanning, repositories are accessed, and the data extractor extracts the API Endpoints described in the API spec file (e.g., swagger file), as well as their request and response structure, their hierarchical descriptions from the specification file, and the actions (the HTTP actions) permitted by the endpoint. These endpoints are rev-centric Part clues. Further, the data extractor extracts Package/library dependencies (e.g., go.mod in the case of golang) and standard files describing the build configurations of a package or repository. Through the build specification, the Part discovery module constructs dev-centric Part clues for Parts linked. The data extracted from Git using an extractor suitable for the Git repository is converted into a standard format record and is transferred and stored in data storage 508 in the form of Git data, wherein the generated standard format file (like JSON) is stored in the data storage 508. A suitable data extractor of the Part discovery module extracts the data from sources like Datadog. The APIs exposed by datadog are used to pull a conceived service map with dependencies. The data extracted from the customer's datadog using an extractor suitable for the datadog repository is converted into standard format record and stored in data storage 508 in form datadog data, wherein the generated standard format file (like JSON file) is transferred and stored in the data storage 508.

In one of the exemplary embodiments, the data extractors extract data from existing organization Parts (DevOrg) 510. Every dev Part is transformed into a Dev Clue (development clue), and service dependencies are transformed into links between clues. Existing DevOrg Parts and pinning information (user modifications to Parts) are fetched by querying the “Parts” service and transformed into clues.

A suitable data extractor of the Part discovery module extracts the data from a source like Kubernetes. The Part discovery module currently uses a kubernetes collector 504, which periodically gathers data at configured frequency using core kubernetes APIs to get microservice data (which is transformed to a Dev Part clue). Data is sent to the unified platform 100 cloud over HTTPS. Once the cloud receives the data, it gets securely stored in data storage, and this collected data contains services, pods, and ingress information. This data, in turn, is used by the Part discovery module first to create clues and ultimately to deduce appropriate Dev/Rev Parts and potentially some links between the Parts. The data extracted from kubernetes collector 504 is converted into a standard format record and stored in data storage 508 in the form of pods, services, and ingress data, wherein the generated standard format file is transferred through an API call and stored in the data storage 508.

In accordance with one of the exemplary embodiments, the Git-Actions are extracted and converted into Dev clues. The customers can connect their GitHub profiles to their organizational accounts. They can set up a GitHub web-hook to push real-time Git actions, such as branches created or newly pushed commits to the respective organization. They can associate PRs with the organization's work items (primarily issues). Each Dev Part is related to a repository, and the Git-actions are converted into Dev clues based on the pull requests (PR) within the repository. Suppose no dev Part is associated with the repository corresponding to the gitaction/PR. In that case, such an event is added to a database collection that can be further used as a Dev Clue by the Part discovery module. A pull request (PR) is associated with an issue in the organization's workplace related to a Rev Part (a feature). Based on the PR's repository, the Part discovery module connects its dev and rev Parts. Real-time data from git actions (e.g., pull request opened) and pull request's associated issues is obtained through GitHub webhook, through the gateway into the Partiql service. It is processed in the Partiql service 512 and stored as Git Events in the database (like Part discovery module events collection).

In accordance with one of the exemplary embodiments of the present specification, the clues extracted from multiple sources are stored in the data storage of the Part discovery module, wherein data extracts generated from each data source are stored independently (such as pods and ingress data extracted from kubernetes, git data, and datadog data).

The extractor 502 or the data acquisition engine 314 may acquire heterogenous data of varying data types from a variety of data sources, such as data sources, 516-1, 516-2, 516-3, and 516-4. In an example, but not limited thereto, the data source 516-1 may be a version control system, for example, GitHub® in the user ecosystem 126. Further, a data source 516-2 may be a monitoring and analytics system, for example, Datadog® at the user ecosystem 126. Furthermore, the data source 516-3 may be a record of a Git-action. Additionally, the data source 516-4 may be a k8s collector (cron job, Kubernetes cluster). The exemplary data sources are shown in FIG. 5A.

For each data source type, the data acquisition engine 314 may employ an acquisition tool, for example, the connectors, the rovers, the APIs, as explained above. The acquisition tools may store all the acquisition data. The acquisition data 324 may be accessed by the seed generation engine 320 that may process the acquisition data and convert the acquisition data into the clue. The clue is interchangeably referred herein as product parameter seed. The product parameter seed may be an isomorphic form of a hierarchical product parameter, which may comprise all data fields or attributes defined in the hierarchical product parameter.

The heterogenous data may include event data, structured data, non-structured data, and the like. For example, for cloud-scale applications, event data may be acquired from monitoring of servers, databases, tools, and services through a SaaS-based data analytics platform (for instance, Datadog®). Further, event data such as data change monitoring (for instance, from GitHub®) may also be acquired by the data acquisition engine 314. The acquisition data 324 may be, in an example, normalized and converted into an open standard format or a data interchange format (like JSON) for ease of reference by different engine(s) in the system 120.

In another example, the data source 516-3, for example, the container orchestration system, may include a data acquisition tools installed on an entity cluster in the discrete ecosystem. The container orchestration system may be explained herein with respect to the Kubernetes® platform, but is not limited thereto. The entity cluster may refer to a cluster of entities where different instances of one or more Kubernetes® services may be running. The entity cluster may include a Kubernetes® collector installed on the entity cluster to gather data on the Kubernetes® services deployed in, for example, the user ecosystem 126. The data collected by the Kubernetes® collector may be acquired by the data acquisition engine 314 using, for example, an API call. The data acquisition engine 314 may convert the acquired data into an open standard format file (for example, JSON) and upload to a data store 506 through the API call which goes through the gateway 504.

In yet another example, data acquisition through the data source 502-1, for example, the version control system, is explained herewith with respect to a GitHub® system as an example, but the same is not limited thereto. The data acquisition engine 314 may obtain real-time event data from Git Actions (e.g., pull request opened) and pull request's associated issues through GitHub webhook, via the gateway 504. The data acquisition engine 314 may process the acquired data and store the processed in the data store 506 as Git Events. In an example, the data acquisition engine 314 may use Partiql® service for processing the acquired data. The acquired data (such as Git data, datadog service data, pods, ingress data, Git Events, and the like) is transferred to a seed generation engine 320 which may generate a product parameter seed that is meaningful data extract (isomorphic variation of a hierarchical product parameter) to automate the generation of the hierarchical product parameter (capability 202, feature 204, microservice 206, sub-module 208) related to the offering 200. The acquired data 324 may either be directly transferred to the seed generation engine 320 or via the insight derivation engine 316 and the augmentation engine 318 as explained in detail with respect to FIG. 3.

The data acquisition engine 314 may acquire data from distinct sources like user-end Git, for example, data source 516-1 and user-end Datadog data records, for example, data source 516-2. The data from a version control system like GitHub® may be acquired based on an established connection of a user entity or a CRM entity to a Git provider (GitHub®, Gitlab, etc.). During scanning, the data acquisition engine 314 may access repositories and may obtain heterogenous data, for example, API Endpoints described in the API spec file (e.g., swagger file), as well as their request and response structure, relational context information from the specification file, and the actions (the HTTP actions) permitted by the endpoint.

The data acquisition engine 314 may use an acquisition tool suitable for a Git repository to obtain one or more sets of telemetry information from the Git repository linked to a user entity. The acquired data 324 may be converted into a standard format record and is transferred and stored in a data store 506 in the form of Git data. The generated standard format file (like JSON) is stored in the data store 506.

The data acquisition engine 314 may use a data acquisition tool suitable to obtain sets of telemetry data from sources like Datadog, for example, data source 516-2. The APIs exposed by datadog may be used to pull a conceived service map with dependencies. The acquisition data 324 comprising sets of telemetry information from the user entity datadog service may be converted into standard format record and stored in the data store 506 in the form of datadog data, where the generated standard format file (like JSON file) is transferred and stored in the data store 506.

In one of the exemplary embodiments, the data acquisition engine 314 may acquire sets of telemetry information from existing hierarchical product parameters, for example, in the development ecosystem 106. Every existing set of telemetry information is transformed into a product parameter seed for the development ecosystem 106, and service dependencies are transformed into links between different hierarchical product parameters. Existing sets of telemetry information including, among others, pinning information describing user modifications to the existing hierarchical product parameters are fetched by querying the development ecosystem 106 and the acquired sets of telemetry information is transformed into product parameter seeds.

In addition to the above, the data acquisition engine 314 may acquire data from the data source 516-4 from a containerization system like Kubernetes®. In the example, the data acquisition engine 314 may use a Kubernetes collector, which periodically gathers data at configured frequency using core Kubernetes APIs to obtain microservice data. The acquisition data 324 may be transformed to a product parameter seed executable to generate a hierarchical product parameter to be integrated with the development ecosystem 106).

The data acquisition engine 314 may in an example transmit the acquisition data 324 over cloud over HTTPS via the communication engine 312. Once the cloud receives the acquisition data 324, the acquisition data 324 may get securely stored in the data store 506. The acquisition data 324 may include services, pods, and ingress information. The data store 506 may also be stored locally in the system 120. The acquisition data 324, in turn, may be used by the system 120 to first create product parameter seeds that may be executable to ultimately deduce appropriate hierarchical product parameters and potentially some links between the hierarchical product parameters. The data acquired from the Kubernetes source 516-4 is converted into a standard format record and stored in data store 506 in the form of pods, services, and ingress data, wherein the generated standard format file is transferred through an API call and stored in the data store 506.

In accordance with one of the exemplary embodiments, the data acquisition engine 314 may obtain Git-action from the data source 516-3. The Git-Actions may be processed in a manner discussed in relation to FIG. 3A, to generate product parameter seeds. The product parameter seeds may, in the present example for explanatory purposes, be related to hierarchical product parameters operating in the development ecosystem 106, but not limited thereto. The entities operating in the connected environment may connect their individual GitHub profiles to the system 120. Such entities may set up a GitHub web-hook to push real-time Git actions, such as branches created or newly pushed commits to the system 120. The data acquisition engine 314 may acquire the data and the insight derivation engine 316 may associate Pull Requests with actionable items (for example, primarily issues with respect to the development ecosystem 122) in the sets of telemetry information. Each developer entity 122-1 may be related to a repository, and the Git-actions may be converted into product parameter seeds associated with the development ecosystem based on the pull requests (PRs) within the repository. In case no hierarchical product parameter belonging to developer-based hierarchy 102 is associated with the repository corresponding to the git-Action/PR, an event is added to a database collection that can be further used as a product parameter seed by the system 120. A PR may be associated with an issue in the connected system related to, for example, a feature in the user ecosystem 126. Based on the PR's repository, the system 120 may connect the developer entities 122-1 and the user entities 126-1. Real-time data from git actions (e.g., pull request opened) and pull request's associated issues is obtained through GitHub webhook, through the gateway into the insight derivation engine 316. The insight derivation engine 316 may process the acquired data and store the acquired data as Git Events in the data store 506 (for example, events collection). Further, the insight derivation data 326 stored by the insight derivation engine 316 may be augmented to the raw telemetry information obtained, as explained above, by the augmentation engine 318 and in accordance with the disclosure in FIG. 3. The augmentation data 328 may then be used by the seed generation engine 320 to generate product parameter seeds. Alternatively, the raw sets of telemetry information may be obtained directly by the seed generation engine 320 to generate product parameter seeds.

In accordance with one of the exemplary embodiments of the present specification, the product parameter seeds may be extracted from a plurality of connected sources and stored in the data storage of the system 120. Further, the sets of telemetry information obtained from each data source are stored independently (such as pods and ingress data extracted from Kubernetes®, git data, and datadog data).

In accordance with one of the exemplary embodiments, product parameter seeds may be transformed into hierarchical product parameters associated with one or more of the discrete ecosystems operating in the connected environment. For a hierarchical product parameter at the development ecosystem 122, distinct source data is differentiated, and code work is developed to deduce product parameter seeds (such as commits or PRs linked to an enhancement). A group of product parameter seeds (grouped by identifying similarities) may be transformed into a hierarchical product parameter. For example, the product parameter seed may include a JSON file usable to form a hierarchical product parameter in the development ecosystem 106:

```
... DevClue struct {
  DevPartType
  Extractor
  Source
  Id
  Name
  ...
}
```

Similarly, for the user ecosystem 126, product parameter seeds may be grouped based on their API endpoint paths and then each product parameter seed may be transformed into a hierarchical product parameter. Non-grouped API paths may be grouped as a miscellaneous user-end hierarchical product parameter. For example, the product parameter seed may include a JSON file usable to form a hierarchical product parameter in the user ecosystem 126:

```
RevClue struct {
  rev_Part_type
  id
  extractor
  source
  name
  api_operations: [{id
          name
          cluster_name
          versions: {apiv2: [{source
                    repo_name
                    repo_path
                    param_paths}],
              },
          http_operation
          parameters: [{name,
                  type}],
          api_path
          cluster_api_path}]
  ...
}
```

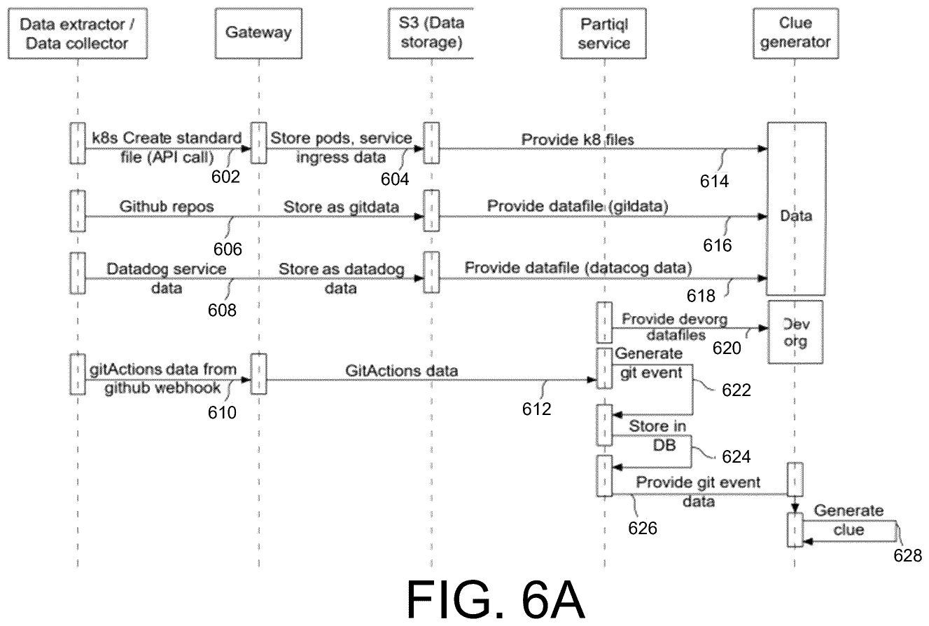

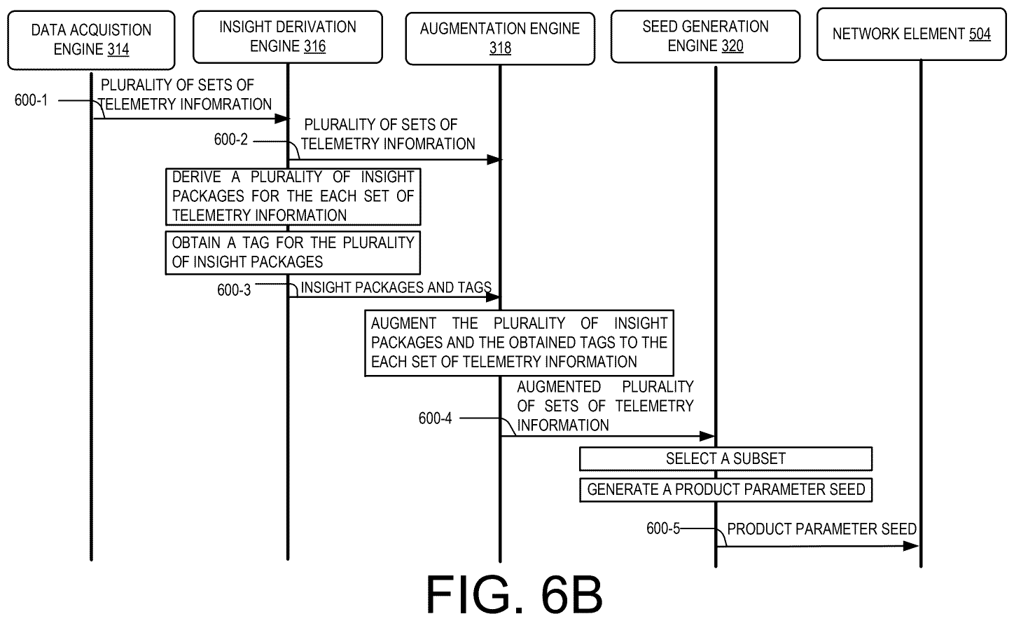

FIG. 6A illustrates a process of extraction and conversion of clues, in accordance with one of the embodiments of the present subject matter. FIG. 6B illustrates a data flow for facilitating generation of the product parameter seed, in accordance with an example implementation of the present subject matter. FIGS. 6A and 6B have been explained in conjunction. In the following description of FIGS. 6A and 6B, reference will be made to the elements and features described in FIGS. 1 to 5B and the detailed description provided above. For the sake of brevity, the full descriptions of these elements and features will not be reproduced here, but are incorporated by reference and should be understood as applicable to the discussion of FIGS. 6A and 6B. FIGS. 6A and 6B have been explained to provide an exemplary implementation of the system 120 described in FIG. 3.

In accordance with an exemplary embodiment as depicted in FIG. 6A, the data extractor, like the kubernetes collector, gathers data on the kubernetes services deployed in the customer environment, constructs a standard format 602, and uploads it to data storage 604 through an API call which goes through the gateway service, and further transfers to the clue generator 614. The data collection service connects to the customer's GitHub® repo(s) 606 and datadog service 608 (based on what the customer configures), gathers data, constructs standard format files (like JSON), and uploads them to data storage. The data from different sources is stored in data storage separately as Git data 606 and customer datadog data 608. Git data 606 and customer datadog data 608 are transferred to the clue generator (616, 618). The data from DevOrg 620 that comprise real-time events (update, modify, delete, add) executed on the existing Parts (Parts' table) is extracted from the Partiql service and transferred to the clue generator 626. Real-time data from git actions data 612 (e.g., pull request opened) and pull request's associated issues is obtained through GitHub webhook 610, through the gateway into the Partiql service. It is processed in the Partiql service 622 and stored in Mongo as Git Events 624. The clue generator transforms the extracted data into a common Part clue format. The git event data is transferred to clue generator 626, and the clue generator analyzes the data extracted from all the sources and generates clue 628. The clue generator is invoked through an API at regular intervals to generate clues and ultimately create the Rev Parts and Dev Parts interconnect such Dev and Rev Parts and update the Parts' table in the event hierarchy of the organization.

In other words, the data extractor corresponding to the data acquisition engine 314 may acquire data from the kubernetes collector, to gather sets of telemetry information associated with data on the kubernetes services deployed in the user ecosystem 126. The data acquisition engine 314 may construct a standard format for the acquisition data 324 and transmit the acquisition data 324 to a data storage, for example, the data store 506 through an API call which goes through a gateway service, for instance the gateway 506.

Further, the data acquisition engine 314 may acquire plurality of sets of telemetry information. The data acquisition engine 314 may acquire data from an entity's GitHub repo(s) and datadog service (based on the entity configuration), gather data, construct standard format files (like JSON), and upload them to the data store 506. The sets of telemetry information from different connected data sources may be stored in data storage separately, for example, as Git data and datadog data.

The telemetry information from the development ecosystem 106 may include real-time events (update, modify, delete, add) executed on the existing hierarchical product parameters. The real-time events may be acquired using a Partiql® service. Real-time data from git actions data (e.g., pull request opened) and pull request's associated issues is obtained through GitHub webhook, through the gateway into the Partiql® service. The git actions data may be processed by the Partiql® service and stored in a data store such as a MongoDB as Git Events.

The plurality of sets of telemetry information may be transmitted to the insight derivation engine 316 at 600-1 and the augmentation engine 318 at 600-2. The insight derivation engine 316 may derive a plurality of insight packages for each set of telemetry information. Further, the insight derivation engine 316 may obtain a tag for the plurality of insight packages. Each tag may be a reference for identifying one insight package, acting as a unique identifier or label for the insight package. At 600-3, the insight packages and the tags may be transmitted to the augmentation engine 318. The augmentation engine 318 may augment the plurality of insight packages and the obtained tags to each set of telemetry information. Further, at 600-4, the augmented plurality of sets of telemetry information may be transmitted to the seed generation engine 320. The seed generation engine 320 may select a subset from the augmented plurality of sets of the telemetry information and generate a product parameter seed based on the subset.

The seed generation engine 320 may transform the augmentation data 328 into a common format. The git event data is transferred to seed generation engine 320, and the seed generation engine 320 analyzes the data extracted in relation to all the connected data sources and generates product parameter seeds. The seed generation engine 320 may be invoked through an API at regular intervals to generate product parameter seeds and ultimately use the generated product parameter seeds to obtain hierarchical product parameters in the discrete ecosystems. The obtained hierarchical product parameters may be interconnected within the discrete ecosystems and integrated into an existing hierarchy related to an offering, such as the offering 200. In an example, the obtained hierarchical product parameters may be a modified version of a previously existing hierarchical product parameter.

In accordance with the embodiments, generation of the product parameter seed is dependent on various data resources (wherein resources are generic (multiple event records or databases) but entity-specific; not all resources are mandatory), which are typically used by the entities within the discrete ecosystems to gather product parameter seeds (meaningful data extracts) which will be essential for deducing hierarchical product parameters. The present techniques of generating product parameter seeds are easily extensible to multiple resources. The acquisition data 324 (extracted and converted) may be converted to product parameter seeds in a uniform format. At 600-5, the seed generation engine 320 may transmit the product parameter seed executable to obtain the hierarchical product parameter.

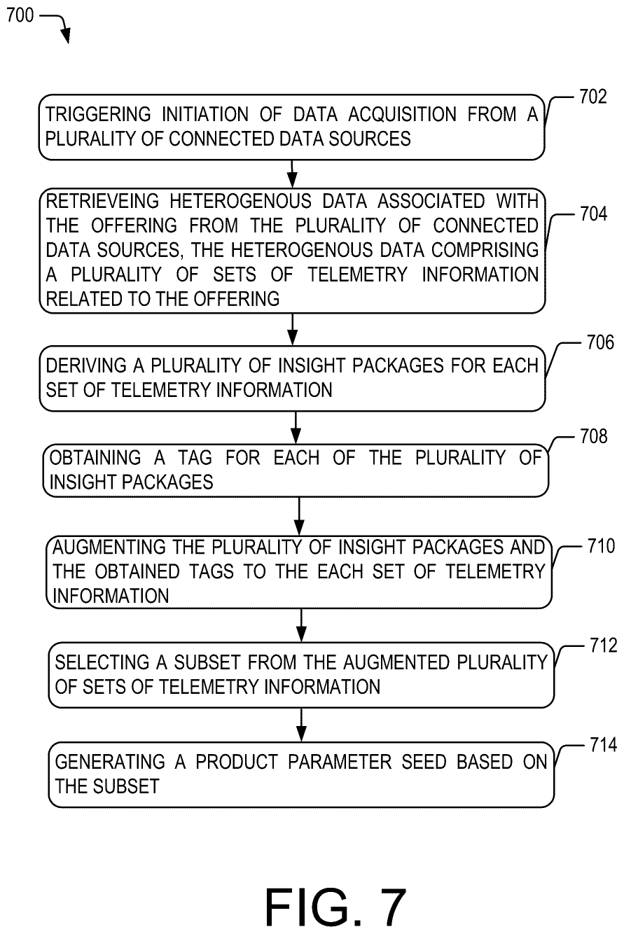

FIG. 7 illustrates a block diagram of a method for facilitating generation of a product parameter seed, in accordance with an example implementation of the present subject matter. Although the method 700 may be implemented in a variety of devices, but for the ease of explanation, the description of the method 700 is provided in reference to the above-described system 120. The order in which the method 700 is described is not intended to be construed as a limitation, and any number of the described method blocks may be combined in any order to implement the method 700, or an alternative method.

It may be understood that blocks of the method 700 may be performed in the system 120. The blocks of the method 700 may be executed based on instructions stored in a non-transitory computer-readable medium, as will be readily understood. The non-transitory computer-readable medium may comprise, for example, digital memories, magnetic storage media, such as magnetic disks and magnetic tapes, hard drives, or optically readable digital data storage media.

At block 702, initiation of data acquisition is triggered from a plurality of connected data sources. Each connected data source may be a data source from amongst the plurality of connected data sources being operated in connection with the unified platform. The triggering may occur in response to receiving a data retrieval signal from an entity connected to the unified platform. The data retrieval signal may be generated automatically on a scheduled basis, in response to certain events, or manually initiated by a user. Further, the data retrieval signal may be analyzed to determine presence of any marked data sources for targeted data acquisition.

At block 704, heterogenous data associated with the offering is retrieved from the plurality of connected data sources. The heterogenous data comprising a plurality of sets of telemetry information related to the offering in the plurality of connected data sources. Each of the plurality of sets of telemetry information comprises a diversified set of attributes associated with the offering. The heterogeneous data comprises a plurality of sets of telemetry information related to the offering. The retrieval process may involve using various data acquisition tools such as connectors, rovers, or APIs, depending on the nature of each connected data source. Prior to the data acquisition, the data acquisition tools may be authenticated and necessary access permissions may be received. If presence of one or more marked data sources was determined in the data retrieval signal, the heterogenous data is obtained from the marked sources.

At block 706, a plurality of insight packages is derived for each set of telemetry information. Each of the plurality of insight packages includes at least a set of semantic information and a set of contextual markers. Each of the plurality of insight packages may be understood as a discrete data set associated with each set of telemetry information. The insight package derivation may involve using advanced data processing techniques, including but not limited to natural language processing, machine learning algorithms, and statistical analysis. A large language processing model may be employed to extract semantic information and contextual markers from the telemetry information. The insight packages may include sets of semantic information and sets of contextual markers. Further, the sets of contextual markers may contain relational context information.

At block 708, a tag is obtained for each of the plurality of insight packages. Each tag may be a reference for identifying one insight package, acting as a unique identifier or label for the insight package. The tagging process may utilize automated classification algorithms, user-defined taxonomies, or a combination of both. Multiple tags may be assigned to a single insight package to enhance cross-referencing capabilities.

At block 710, the plurality of insight packages and the obtained tags are augmented to each set of telemetry information. The augmentation may involve creating data structures that link the telemetry information with its corresponding insight packages and tags, potentially using key-value stores or graph database structures. The augmentation may preserve any relational context information, maintaining the interconnected nature of the sets of telemetry information.

At block 712, a subset is selected from the augmented plurality of sets of telemetry information. The selection may be based on a set of rules defining parameters relevant for generating the hierarchical product parameter. The rules may include user-initiated filtering criteria or predefined selection algorithms. The selection may also utilize relational context information to identify interconnected data points.

At block 714, a product parameter seed is generated based on the subset. The product parameter seed is a structured data object comprising information associated with each augmented set of telemetry information in the subset of the augmented plurality of sets of telemetry information. The generation may involve normalizing the selected data, extracting key features, and synthesizing relevant information into the structured data object. For example, the product parameter seed may be formatted as a JSON, XML, or YAML file, containing comprehensive information about the hierarchical product parameters. The generated seed may incorporate relational context information to provide a more comprehensive view of the offering's structure and dependencies.

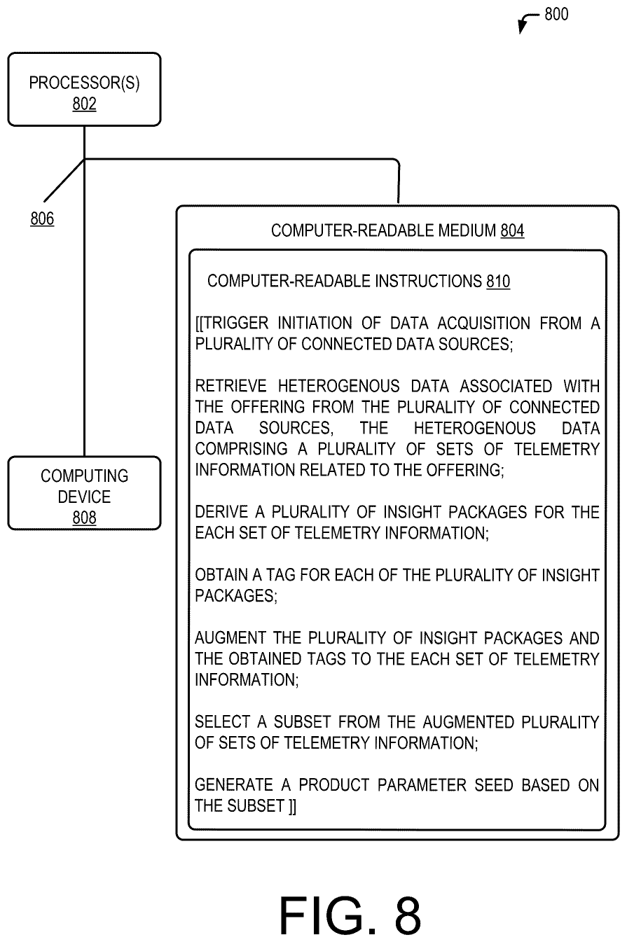

FIG. 8 illustrates a non-transitory computer-readable medium for facilitating generation of a product parameter seed, in accordance with an example of the present subject matter.

In an example, the computing environment 800 comprises processor(s) 802 communicatively coupled to a non-transitory computer-readable medium 804 through communication link 806. In an example, the computing environment 800 may be, for example, the system 120. In an example, the processor(s) 802 may have one or more processing resources for fetching and executing computer-readable instructions 810 from the non-transitory computer-readable medium 804. The processor(s) 802 and the non-transitory computer-readable medium 804 may be implemented, for example, in the system 120.

The non-transitory computer-readable medium 804 may be, for example, an internal memory device or an external memory. In an example, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example, the non-transitory computer-readable medium 804 comprises a set of computer-readable instructions 810 which may be accessed by the processor(s) 802 through the communication link 806 and subsequently executed for facilitating optimization of cellular network performance of the network element. The processor(s) 802 and the non-transitory computer-readable medium 804 may also be communicatively coupled to a system 120 over the network. The processor(s) 802 and the non-transitory computer-readable medium 804 may also be communicatively coupled to a computing device 808 through the communication link 806.

Referring to FIG. 8, in an example, the non-transitory computer-readable medium 804 comprises computer-readable instructions 810 that cause the processor(s) 802 to trigger initiation of data acquisition from a plurality of connected data sources. Each connected data source from amongst the plurality of connected data sources may be operated in connection with the unified platform. Triggering initiation of data acquisition may involve sending requests to various data sources, establishing secure connections, and preparing to receive incoming data streams. The computer-readable instructions 810 may include error handling and retry mechanisms to ensure robust data acquisition. The computer-readable instructions 810 may include steps to identify any marked data sources specified in the data retrieval signal, directing the acquisition process accordingly.

In an example, the computer-readable instructions 810 may then cause the processor(s) 802 to retrieve heterogenous data associated with the offering from the plurality of connected data sources. The heterogenous data may include a plurality of sets of telemetry information related to the offering. Each of the plurality of sets of telemetry information may include a diversified set of attributes associated with the offering. The retrieval may involve parallel processing to handle multiple data streams simultaneously, data validation, and transformation of data into a standardized format for further processing. If marked data sources are determined to be present in the data retrieval signal, the instructions cause the processor to target the data retrieval from the marked sources, potentially optimizing resource allocation and processing time.

The computer-readable instructions 810 may then cause the processor(s) 802 to derive a plurality of insight packages for each set of telemetry information. Each of the plurality of insight packages may include at least a set of semantic information and a set of contextual markers. Further, each of the plurality of insight packages is a discrete data set associated with each set of telemetry information. The processor(s) 802 may utilize various analytical techniques, potentially leveraging cloud-based services for enhanced processing power when dealing with large datasets. The instructions may include provisions for dynamically selecting the most appropriate analytical technique based on the nature of the telemetry information. For deriving the plurality of insight packages, the instructions may cause the processor(s) 802 to extract relational context information, which provides data on how different sets of telemetry information are interconnected within the unified platform 100.

In the example, the computer-readable instructions 810 may then cause the processor(s) 802 to obtain a tag for each of the plurality of insight packages. The tagging may involve both automated classification algorithms and user-defined taxonomies. The instructions may include mechanisms for resolving conflicts in tag assignments and for updating tag hierarchies based on new insights. Further, the computer-readable instructions 810 may then cause the processor(s) 802 to augment the plurality of insight packages and the obtained tags to each set of telemetry information. The augmentation may include creating backup copies of the original telemetry information to ensure data integrity throughout the process. The augmentation may include creating data structures that efficiently link the telemetry information with its corresponding insight packages and tags, potentially using advanced indexing techniques for quick retrieval.

In the example, the computer-readable instructions 810 may then cause the processor(s) 802 to select a subset from the augmented plurality of sets of telemetry information. Further, the computer-readable instructions 810 may cause the processor(s) 802 to generate a product parameter seed based on the subset. The product parameter seed may be executable to obtain the hierarchical product parameter.

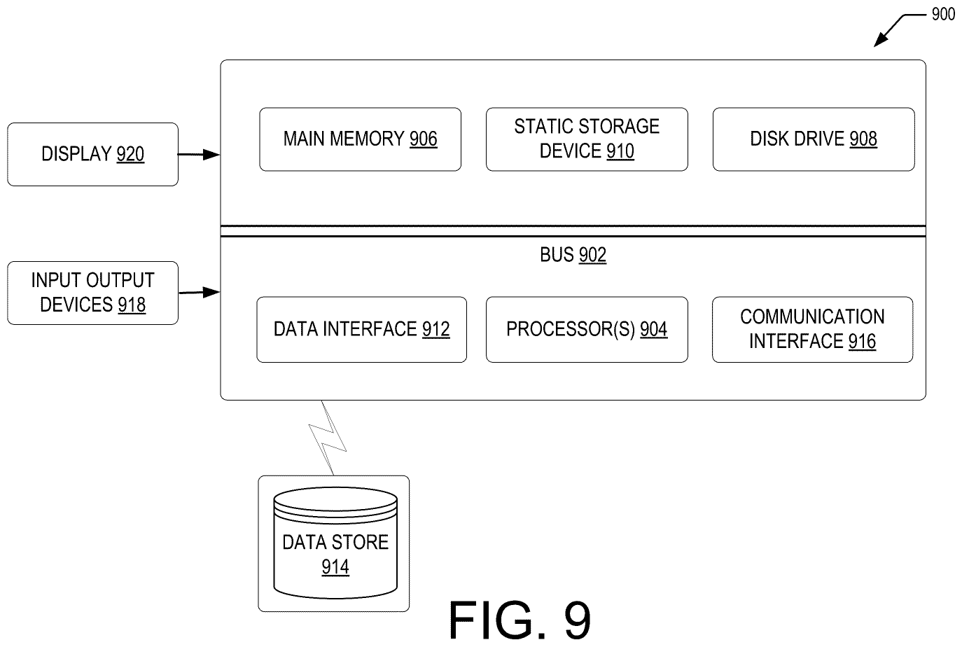

FIG. 9 is a block diagram of an illustrative computing processing system 900 suitable for implementing an embodiment of the present invention. The computer processing system 900 comprises a processing unit, a communications interface, and a non-transitory computer-readable storage medium to store instructions, wherein the processing unit executes the stored instructions to perform protocol implementation, internal authorization, handling of the access tokens, revoking of access tokens, validating third-Party services tokens, and refreshing a token. Computer processing system 900 includes a bus 902 or another communication mechanism for communicating information, which interconnects subsystems and devices, such as processor(s) 904, main memory 906 (e.g., RAM), static storage device 910 (e.g., ROM), disk drive 908 (e.g., magnetic, or optical), communication interface 916 (e.g., modem or Ethernet card), display 920 (e.g., CRT or LCD), input/output devices 918 (e.g., keyboard), and cursor control.

According to one embodiment of the invention, computer processing system 900 performs specific operations by processor(s) 904 executing one or more sequences of one or more instructions contained in main memory 906. Such instructions may be read into the main memory 906 from another computer-readable/usable medium, such as static storage device 910 or disk drive 908. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware used to implement all or Part of the invention.

The term “computer-readable medium” or “computer-usable medium,” as used herein, refers to any medium that Participates in providing instructions to processor(s) 904 for execution. Such a medium may take many forms, including, but not limited to, non-volatile media and volatile media. Non-volatile media includes, for example, optical or magnetic disks, such as disk drive 908. Volatile media has dynamic memory, such as main memory 906. A data store 914 may be accessed in a computer-readable medium (not shown in FIG. 9) using a data interface 912.

Typical forms of computer-readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip, or cartridge, or any other medium from which a computer can read.

In an embodiment of the invention, execution of the sequences of instructions to practice the invention is executed by a single computer processing system 900. According to other embodiments of the invention, two or more computer systems 900 coupled by a communication link (e.g., LAN, PTSN, or wireless network) may perform the sequence of instructions required to practice the invention in coordination.

The computer processing system 900 may transmit and receive messages, data, and instructions, including program, i.e., application code, through the communication link and a communication interface 916. Received program code may be executed by processor 904 as it is received and/or stored in disk drive 908 or other non-volatile storage for later execution.

In a typical configuration, the computer includes one or more processors (CPU), an input/output interface, a network interface, and a memory. The memory can consist of a non-persistent memory, a random-access memory (RAM), and/or a non-volatile memory in a computer-readable medium, for example, a read-only memory (ROM) or a flash memory (flash RAM). Memory is an example of a computer-readable medium.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system to generate product parameter seeds executable to obtain a hierarchical product parameter for an offering operating in a unified platform, the system comprising:
a processor to:
trigger, in response to receipt of a data retrieval signal, initiation of data acquisition from a plurality of connected data sources, each connected data source from amongst the plurality of connected data sources being operated in connection with the unified platform;
retrieve heterogenous data associated with the offering from the plurality of connected data sources, wherein the heterogenous data comprises a plurality of sets of telemetry information related to the offering in the plurality of connected data sources, wherein each of the plurality of sets of telemetry information comprises a diversified set of attributes associated with the offering;
generate the product parameter seeds, wherein the product parameter seed is a structured data object; and
cause generation of a signal for transmission of the product parameter seeds executable to obtain the hierarchical product parameter.

2. The system of claim 1, wherein to generate the product parameter seeds, the processor is to:
derive a plurality of insight packages for the each set of telemetry information, each of the plurality of insight packages comprising a set of semantic information and a set of contextual markers and each of the plurality of insight packages being a discrete data set associated with the each set of telemetry information, wherein the processor is to obtain a tag for each of the plurality of insight packages, each tag being a reference for identifying one insight package;
augment the plurality of insight packages and the obtained tags to the each set of telemetry information from amongst the plurality of sets of telemetry information;
select, based on a set of rules defining parameters relevant for generating the hierarchical product parameter, a subset from the augmented plurality of sets of telemetry information; and
generate the product parameter seeds based on the subset.

3. The system of claim 2, wherein the structured data object comprises information associated with the each augmented set of telemetry information in the subset of the augmented plurality of sets of telemetry information.

4. The system of claim 1, wherein, prior to triggering the initiation of data acquisition, the processor is to determine whether the data retrieval signal comprises reference to a marked data source from amongst the plurality of connected data sources, the marked data source being identified in the data retrieval signal as a target for directing the data acquisition; and
trigger, based on the determination, initiation of data acquisition from the marked data source.

5. The system of claim 1, wherein to retrieve the heterogeneous data, the processor is to:
obtain access permission from the plurality of connected data sources, the access permission being a level of authorization granted by the connected data source for interaction with data of the connected data source;
wherein the access permission comprises at least a read permission.

6. The system of claim 2, wherein to derive the plurality of insight packages, the processor is to execute a large language processing model to extract the set of semantic information and the set of contextual markers from the plurality of sets of telemetry information.

7. The system of claim 2, wherein the set of rules comprises a user-initiated filtering criterion.

8. The system of claim 2, wherein the set of contextual markers comprises at least one of timestamp, geolocation, and originating device information.

9. The system of claim 1, wherein the structured data object is one of a JavaScript Object Notation (JSON) file, an Extensible Markup Language (XML), Ain′t Markup Language (YAML), Protocol Buffers, and combinations thereof.

10. The system of claim 2, wherein the set of contextual markers comprises relational context information, the relational context information including data indicative of relationships between one or more of the plurality of sets of telemetry information within the unified platform; and
the processor is further to:
analyze the relational context information to identify at least one of dependencies, correlations, and hierarchical relationships between the plurality of sets of telemetry information to derive the plurality of insight packages; and
utilize the relational context information in the selection of the subset from the augmented plurality of sets of telemetry information.

11. A method for generating product parameter seeds executable to obtain a hierarchical product parameter for an offering operating in a unified platform, the method comprising:
triggering, in response to receipt of a data retrieval signal, initiation of data acquisition from a plurality of connected data sources, each connected data source from amongst the plurality of connected data sources being operated in connection with the unified platform;
retrieving heterogenous data associated with the offering from the plurality of connected data sources, wherein the heterogenous data comprises a plurality of sets of telemetry information related to the offering in the plurality of connected data sources, wherein each of the plurality of sets of telemetry information comprises a diversified set of attributes associated with the offering;
generating the product parameter seeds, wherein the product parameter seed is a structured data object; and
causing generation of a signal for transmission of the product parameter seed executable to obtain the hierarchical product parameter.

12. The method of claim 11, wherein for generating the product parameter seeds, the method comprises:
deriving a plurality of insight packages for the each set of telemetry information, each of the plurality of insight packages comprising a set of semantic information and a set of contextual markers and each of the plurality of insight packages being a discrete data set associated with the each set of telemetry information,
obtaining a tag for each of the plurality of insight packages, each tag being a reference for identifying one insight package;
augmenting the plurality of insight packages and the obtained tags to the each set of telemetry information from amongst the plurality of sets of telemetry information; and
selecting, based on a set of rules defining parameters relevant for generating the hierarchical product parameter, a subset from the augmented plurality of sets of telemetry information, wherein the product parameter seeds are generated based on the subset.

13. The method of claim 11, further comprising:
determining, prior to triggering the initiation of data acquisition, whether the data retrieval signal comprises reference to a marked data source from amongst the plurality of connected data sources, the marked data source being identified in the data retrieval signal as a target for directing the data acquisition; and
triggering, based on the determination, initiation of data acquisition from the marked data source.

14. The method of claim 12, wherein deriving the plurality of insight packages comprises:
executing a large language processing model to extract the set of semantic information and the set of contextual markers from the plurality of sets of telemetry information.

15. The method of claim 12, wherein the set of contextual markers comprises relational context information, the relational context information including data indicative of relationships between one or more of the plurality of sets of telemetry information within the unified platform; and
the method further comprises:
analyzing the relational context information to identify at least one of dependencies, correlations, and hierarchical relationships between the plurality of sets of telemetry information for deriving the plurality of insight packages; and
utilizing the relational context information in the selection of the subset from the augmented plurality of sets of telemetry information.

16. A non-transitory computer-readable storage medium storing program comprising instructions for generation of product parameter seeds executable to obtain a hierarchical product parameter for an offering operating in a unified platform, the instructions being executable by a processor to:
trigger, in response to receipt of a data retrieval signal, initiation of data acquisition from a plurality of connected data sources, each connected data source from amongst the plurality of connected data sources being operated in connection with the unified platform;
retrieve heterogenous data associated with the offering from the plurality of connected data sources, wherein the heterogenous data comprises a plurality of sets of telemetry information related to the offering in the plurality of connected data sources, wherein each of the plurality of sets of telemetry information comprises a diversified set of attributes associated with the offering;
generate the product parameter seeds, wherein the product parameter seed is a structured data object; and
cause generation of a signal for transmission of the product parameter seed executable to obtain the hierarchical product parameter.

17. The non-transitory computer-readable storage medium of claim 16, wherein to generate the product parameter seeds, the instructions cause the processor to:
derive a plurality of insight packages for the each set of telemetry information, each of the plurality of insight packages comprising a set of semantic information and a set of contextual markers and each of the plurality of insight packages being a discrete data set associated with the each set of telemetry information, wherein the processor is to obtain a tag for each of the plurality of insight packages, each tag being a reference for identifying one insight package;
augment the plurality of insight packages and the obtained tags to the each set of telemetry information from amongst the plurality of sets of telemetry information; and
select, based on a set of rules defining parameters relevant for generating the hierarchical product parameter, a subset from the augmented plurality of sets of telemetry information;
wherein the product parameter seeds are generated based on the subset.

18. The non-transitory computer-readable storage medium of claim 16, wherein the instructions further cause the processor to:
determine, prior to triggering the initiation of data acquisition, whether the data retrieval signal comprises reference to a marked data source from amongst the plurality of connected data sources, the marked data source being identified in the data retrieval signal as a target for directing the data acquisition; and
trigger, based on the determination, initiation of data acquisition from the marked data source.

19. The non-transitory computer-readable storage medium of claim 17, wherein to derive the plurality of insight packages, the instructions cause the processor to execute a large language processing model to extract the set of semantic information and the set of contextual markers from the plurality of sets of telemetry information.

20. The non-transitory computer-readable storage medium of claim 17, wherein the set of contextual markers comprises relational context information, the relational context information including data indicative of relationships between one or more of the plurality of sets of telemetry information within the unified platform; and
wherein the instructions cause the processor to:
analyze the relational context information to identify at least one of dependencies, correlations, and hierarchical relationships between the plurality of sets of telemetry information to derive the plurality of insight packages; and
utilize the relational context information in the selection of the subset from the augmented plurality of sets of telemetry information.
